(19) United States
(12) Patent Application Publication
(10) Pub. No.: US 2026/0206745 A1
(43) Pub. Date: Jul. 23, 2026

(54) DOUBLE ENCAPSULATED NANOCOMPOSITE FOR STAGED DELIVERY OF ACTIVE INGREDIENT(S), AND A METHOD OF PRODUCING THEREOF

(71) Applicant: COUNCIL OF SCIENTIFIC AND INDUSTRIAL RESEARCH, New Delhi (IN)

(72) Inventors: Rathna Venkata Naga GUNDLOORI, Pune (IN); Tripurari Rao GAUTAM, Pune (IN)

(73) Assignee: COUNCIL OF SCIENTIFIC AND INDUSTRIAL RESEARCH, New Delhi (IN)

(21) Appl. No.: 19/140,656

(22) PCT Filed: Dec. 19, 2023
(86) PCT No.: PCT/IN2023/051195

§ 371 Date: Jun. 18, 2025

(30) Foreign Application Priority Data
Dec. 19, 2022 (IN) 202211073752

(51) Int. Cl. A01N 25/10; A01N 25/12; A01N 25/22; A01P 13/00; A01P 21/00

(52) U.S. Cl. CPC A01N 25/10; A01N 25/12; A01N 25/22; A01P 13/00; A01P 21/00

(57) ABSTRACT

The present invention relates to a carrier system for agrochemicals. Specifically, the present invention relates to a carrier system based on nanocomposites comprising double encapsulated nanocomposite composition for staged delivery of a growth stimulant for a weed and a herbicide for controlling the same. The encapsulation of active ingredients is designed in such a way that growth stimulant is released initially to induce the germination of the weed and then, the herbicides to kill them during the emergence. The present invention also relates to a method of producing the double encapsulated nanocomposite granules and uses thereof.

### TECHNICAL FIELD OF THE INVENTION

The present invention relates to a composition or composite or carrier or delivery system for active ingredients. Specifically, the present invention relates to a composition or carrier or delivery system based on nanocomposites comprising double-encapsulated nanocomposite granules for staged delivery of at least one active ingredient (e.g., herbicides, growth stimulants for plant/weed or any other suitable active ingredient). Specifically, considering the agrochemical application, the present invention relates to the encapsulation of active ingredients designed in such a way that a growth stimulant is released initially to induce the germination of the weed and then, the herbicides to kill them during the emergence. The present invention also relates to a method of producing the double encapsulated nanocomposite granules and uses thereof.

### BACKGROUND AND PRIOR ART OF THE INVENTION

Sugarcane has a prominent position in crops produced in India for sugar and energy production. Growing demand in the Indian scenario enhanced the need to produce 520 million tonnes of sugarcane for sugar and an additional 78 million tonnes of cane for ethanol production by 2030. In this context, Striga infestation becomes a serious weed in Sugarcane. Striga, which is a parasitic weed, causes yield loss in the range of 40-100 percent. Control of Striga in cultivated fields is difficult due to its unique life cycle. It produces thousands of tiny seeds and remains viable for more than ten years in the soil. It germinates on the recognition of signal molecules released from the host plants and attaches haustorium like structures by which it depletes photo-assimilates and nutrients from the host plant. The parasitic interaction with host plants weakens them, causing considerable yield losses.

The intensity of Striga has nexus with soils having less soil fertility and water stress which are exactly the conditions, reflecting the sugarcane growing soils. The general control measures are not effective in controlling the Striga infestation in sugarcane. The situation warrants for exhausting the seed bank of Striga which is in the soil to achieve potent control over the Striga infestation.

There are some reports which cover encapsulated material or carrier, and are given below:

US patent application US20090199314A1 discloses an agent for the agronomic treatment of plants, wherein the agronomic treatment agent is in the form of a microsphere of size ranging from 5 and 500 μm. The said microsphere particles comprise a double membrane structure having a core comprising a grain of a solid material that is inert, an active species for agronomic treatment absorbed into said grain and/or adsorbed onto a surface of the said grain, a membrane encapsulating said core comprising at least one hydrophilic polymer such as PVA and cellulose, and an outer membrane encapsulating said core comprising at least one hydrophobic polymer.

Zineb Elbahri et al., Polymer Bulletin volume 54, pages 353-363 (2005), discloses a controlled-release microencapsulated herbicide formulation comprising ethyl cellulose. The microspheres are prepared by emulsion-solvent evaporation technique, wherein the herbicide 2,4-D was dispersed in DCM or dissolved in DCM/Acetone mixture (90:10, w/w), followed by the addition of ethyl cellulose, and then the mixture was heated with light reflux (30-35° C.) and stirring for one hour to give an organic phase.

However, these US patent and Zineb Elbahri et al., report do not cover a nanofiber membrane with nanocomposite containing 1^{st} active agent, which is further encapsulated with polymeric nanoparticles carrying herbicide as 2^{nd} active agent for staged and controlled release of active agents.

Thus, there is a need to develop a composition or carrier or delivery system based on nanocomposites for the targeted delivery of active ingredients (e.g., agrochemical) to achieve potent control over the weed infestation.

### OBJECTS OF THE INVENTION

An object of the present disclosure is to provide a composition or carrier or delivery system for active ingredients (e.g., agrochemicals) to achieve the required activity.

An object of the present disclosure is to provide a carrier/delivery system for active ingredients (e.g., agrochemicals) to achieve potent control over the weed infestation.

Another object of the present disclosure is to provide a carrier/delivery system based on nanocomposites for staged delivery of active ingredients (a plant growth stimulant and an herbicide for controlling weed).

Another object of the present disclosure is to provide double encapsulated nanocomposite granules for staged delivery of active ingredients (e.g., a plant growth stimulant and an herbicide for controlling weed).

Another object of the present disclosure is to provide a method of producing double encapsulated nanocomposite granules for staged delivery of active ingredients (e.g., a plant growth stimulant and an herbicide for controlling weed).

Yet another object of the present disclosure is to provide a method of controlling Striga weed in sugarcane using double encapsulated nanocomposite granules.

### SUMMARY OF THE INVENTION

Aspects of the present invention relate to a composition or carrier or delivery system for active ingredients (e.g., agrochemicals). Specifically, the present invention relates to a carrier/delivery system based on nanocomposites for staged delivery of active ingredient(s) (e.g., a plant growth stimulant and/or an herbicide for controlling weeds). The encapsulation of active ingredients is designed in such a way that growth stimulant is released initially for growth of plant and then, the herbicides to kill the weeds during the emergence.

In an aspect, the present invention relates to a double encapsulated nanocomposite composition, comprising:
a. a cross-linked ethyl cellulose (EC) nanoparticles,
b. 1^{st} active ingredient,
c. cross-linked gelatin-nanoclay nanofibers, and
d. 2^{nd} active ingredient;
   wherein the cross-linked EC nanoparticles and 1^{st} active ingredient together composed of 1^{st} active ingredient-loaded cross-linked EC nanoparticles as 1^{st} encapsulation,
   wherein the cross-linked gelatin-nanoclay nanofibers and 2^{nd} active ingredient together composed of 2^{nd} active ingredient-loaded cross-linked gelatin-nanoclay nanofibers, and
   wherein the 1^{st} active ingredient-loaded cross-linked EC nanoparticles is within a mat comprising of said 2^{nd} active ingredient-loaded cross-linked gelatin-nanoclay nanofiber forming said double encapsulated nanocomposite composition.

In another aspect, the cross-linked ethyl cellulose (EC) nanoparticles comprise polyvinyl alcohol as stabilizer.

In another aspect, the 1^{st} active ingredient and 2^{nd} active ingredient are same or different, and are selected from herbicide, plant growth stimulator, nutrient, plant disease controlling agent, antibiotic, nucleic acid, and mixture thereof.

In another aspect, the herbicide is selected from a triazine, a chloroacetamide, a 2,6-dinitroaniline, aclonifen, diuron, a hydroxybenzonitrile, 2,4-D, aminopyralid, atrazine, clopyralid, dicamba, glufosinate ammonium, fluazifop, fluroxypyr, imazapyr, imazamox, metolachlor, pendimethalin, picloram, triclopyr, mesotrione and glyphosate.

In another aspect, the plant growth stimulator or stimulant is selected from plant growth hormone, auxin, gibberellins, cytokinin, ABA, ethylene and growth promoting agent.

In another aspect, the plant growth hormone is selected from indole 3 acetic acid, indole butyric acid, naphthalene acetic acid, methyl ester of naphthalene acetic acid, 2 methyl 4-chloro phenoxy acetic acid, 2, 3, 5 Tri iodo benzoic acid, 2, 4 dichloro phenoxy acetic acid, 2, 4, 5-trichloro phenoxy acetic acid, gibberellic acid, kinetin, coconut milk factor, zeatin.

In another aspect, the growth promoting agent is selected from ascorbic acid, strigol, orobanchol, GR24 (synthetic strigolactone), epi-GR24 (synthetic strigolactone), and 5-(4-chlorophenoxy)-3-methylfuran-2 (5H)-one (CPMF).

In another aspect, the nutrient is selected from macronutrient and micronutrient; wherein the macronutrient is selected from salts of C, H, O, N, P, K, Ca, Mg and S; wherein the micronutrient is selected from salts of Fe, Mn, Zn, Cu, B, and Cl.

In another aspect, the plant disease controlling agent is selected from tebuconazole, epoxiconazole, prothioconazole, difenoconazole, propiconazole, cyproconazole, metconazole, triflumizole, tebuconazole and difenoconazole, pefurazoate, ipconazole.

In another aspect, the antibiotic is selected from agrocin 84, bacillomycin D, bacillomycin, fengycin, xanthobaccin A, gliotoxin, herbicolin, iturin A, mycosubtilin, phenazines, pyoluteorin, pyrrolnitrin, pseudane, zwittermicin A, 2,4-diacetylphloroglucinol (2,4-DAPG), phenazine-1-carboxylic acid (PCA), kanosamine, oligomycin A, butyrolactones, xanthobaccin, and viscosinamide.

In another aspect, the nucleic acid is ribose nucleic acid (RNA).

In another aspect, the cross-linked gelatin-nanoclay nanofibers are selected from squaric acid cross-linked, Irgacure 2959 cross-linked and EDC-NHS coupled crosslinked gelatin-nanoclay nanofibers.

In another aspect, the composition is sustained release formulation or controlled release formulation.

In another aspect, the diameter of the mat is in the range of 50 to 1000 nm.

In another aspect, the diameter of the 1^{st} active ingredient-loaded cross-linked EC nanoparticles is in the range of 50 nm to about 500 nm.

In another aspect, the diameter of the 2^{nd} active ingredient-loaded cross-linked gelatin-nanoclay nanofiber is in the range of 1 to 500 nm.

In another aspect, the cross-linked ethyl cellulose (EC) nanoparticles are present in a range of 5-50% w/w.

In another aspect, the cross-linked gelatin-nanoclay nanofibers are present in a range of 10-30% w/v.

In another aspect, the 1^{st} active ingredient is present in a range of 5-50% w/w.

In another aspect, the 2^{nd} active ingredient is present in a range of 5-50% w/w.

In another aspect, the present invention relates to a process of preparation of said double encapsulated nanocomposite composition, the process comprising:
a) preparing ethyl cellulose (EC) nanoparticles by treating ethyl cellulose (EC) with polyvinyl alcohol (PVA) as stabilizer in presence of 1^{st} active ingredient, followed by cross-linking the nanoparticles using CaCl₂ to obtain 1^{st} encapsulation of 1^{st} active ingredient, that is 1^{st} active ingredient-loaded cross-linked EC nanoparticles;
b) mixing 1^{st} active ingredient-loaded cross-linked EC nanoparticles in the solution of gelatin-nanoclay to obtain 1^{st} active ingredient loaded encapsulated nanofibers or 1^{st} active ingredient loaded double encapsulated nanofibers;
c) mixing the 2^{nd} active ingredient and 1^{st} active ingredient loaded crosslinked EC nanoparticles in the solution of gelatin-nanoclay to obtain double encapsulated nanofibers;
d) preparing cross-linked gelatin-nanoclay nanofibers by treating nanofibers or the double encapsulated nanofibers with a specific amount of crosslinkers to obtain the final double encapsulated nanocomposite composition.

In another aspect, the specific amount of crosslinkers is 0.05-50% w/w with respect to the gelatin.

In another aspect, the step a) of above process specifically comprising the steps of:
a. mixing EC and herbicide (1^{st} active ingredient) in dichloromethane (DCM) solvent, followed by stirring for a time period of 8 to 12 hours to obtain EC-herbicide mixture,
b. providing a PVA solution,
c. slowly adding the EC-herbicide mixture into the PVA solution, followed by sonication to obtain a dispersed solution,
d. centrifuging the dispersed solution to obtain a pellet,
e. washing the pellet using water or DI water,
f. dispersing the washed pellet in CaCl₂ solution for cross-linking, followed by stirring to obtain herbicide-loaded cross-linked EC nanoparticles, and
g. washing the herbicide-loaded cross-linked EC nanoparticles, followed by drying to obtain 1^{st} herbicide-loaded cross-linked EC nanoparticles.

In another aspect, the double encapsulated nanocomposite composition and/or the process of step a) as disclosed herein cover the features of: i) PVA solution comprising 0.1-1% w/v of PVA dissolved in water; ii) the EC or EC solution comprises 10% w/v of EC powder dissolved in DCM solvent; iii) the amount of herbicide in said herbicide-loaded cross-linked EC nanoparticles is in the range of 1% w/v to 20% w/v with respect to the weight of EC; iv) a ratio of EC+herbicide:PVA is in range of 1:2 to 1:8; and v) a concentration of CaCl₂ is in the range of 0.2% w/v to 10% w/v.

In another aspect, the process disclosed herein in the step b) comprises:
i. providing a gelatin solution,
ii. mixing a nanoclay in said gelatin solution, followed by stirring to obtain homogeneous blend solution,
iii. preparing gelatin-nanoclay nanofibres by electrospinning method at ambient conditions, and
iv. preparing cross-linked gelatin-Nanoclay nanofibres by in situ or ex situ method to obtain cross-linked gelatin-nanoclay nanofibers.

In another aspect, the double encapsulated nanocomposite composition and/or the process of step b) as disclosed herein cover the features of: i) the nanoclay is halloysite nanoclay; ii) the gelatin is dissolved in water in an amount ranging from about 1% w/v to 20% w/v; iii) an amount of nanoclay is in the range of 0.5% w/v to 10% w/v with respect to the weight of gelatin; and iv) amount of the 2^{nd} active ingredient is in the range of 0.5% w/v to 15% w/v with respect to the weight of gelatin.

In another aspect, the electrospinning method at ambient conditions comprises: a) filling of the homogeneous gelatin-nanoclay solution in a syringe, equipped with a stainless-steel hypodermic needle with a blunt end with a fixed pore; b) mounting the filled syringe on a syringe pump of an electrospinning unit connected with a high-voltage generator operated in a positive DC mode, and an aluminum plate was set in a closed chamber to ground the nanofibers; and c) the ambient conditions for electrospinning comprises a distance between tip of the needle and the collector is in range of 5-35 cm, the voltage is in range of 5-35 kV, and the flow rate is in range of 0.05-5.00 mL/h.

In another aspect, the in-situ method of preparing cross-linked gelatin-Nanoclay nanofibres comprises incorporating a cross-linker directly into the gelatin solution for cross-linking and then fabricating it into nanofibers.

In another aspect, the ex-situ method of preparing cross-linked gelatin-Nanoclay nanofibres comprises dipping the nanofibers from step c) into a solution of cross-linker; and wherein the cross-linker is selected from EDC-NHS (zero length cross-linker), squaric acid (SQ) (non-zero length cross-linker) and Irgacure 2959 (photo-initiator cross-linker).

In an embodiment, the present disclosure provides double encapsulated nanocomposite granules for staged delivery of active ingredient(s) (e.g., a plant growth stimulant and/or an herbicide for controlling weed).

In an aspect, the present disclosure provides a double encapsulated nanocomposite granules comprising:
a. Cross-linked Ethyl cellulose (EC)-PVA nanoparticles,
b. 1^{st} active ingredient within the Cross-linked EC-PVA nanoparticles, which is 1^{st} active ingredient-loaded cross-linked EC-PVA nanoparticles,
c. cross-linked gelatin-Nanoclay nanofibers with or without 2^{nd} active ingredient, and
d. 1^{st} active ingredient-loaded cross-linked EC-PVA nanoparticles within a mat comprising of cross-linked gelatin-Nanoclay nanofibers with or without 2^{nd} active ingredient to form double encapsulated nanocomposite granules.

In another embodiment, the 1^{st} active ingredient and 2^{nd} active ingredient are same or different, selected from herbicides, plant growth stimulators, nutrients, plant disease controlling agents, antibiotics, nucleic acids, or mixtures thereof.

The term “mat” refers to a non-woven nanofibers mat with fiber diameter ranging from 50-800 nm.

In an aspect, the present disclosure provides a method for producing double encapsulated nanocomposite granules for staged delivery of a growth stimulant of plant as 2^{nd} active ingredient and an herbicide as 1^{st} active ingredient for controlling the weeds.

In an aspect, the present disclosure provides a method for producing double encapsulated nanocomposite granules comprises the steps of:
a. Preparing ethyl cellulose (EC) nanoparticles using PVA in presence of 1^{st} active ingredient, followed by crosslinking the nanoparticles using CaCl₂ to obtain 1^{st} encapsulation of 1^{st} active ingredient, that is 1^{st} active ingredient-loaded cross-linked EC nanoparticles;
b. mixing 1^{st} active ingredient-loaded cross-linked EC nanoparticles in the solution of gelatin-nanoclay to obtain 1^{st} active ingredient loaded encapsulated nanofibers or 1^{st} active ingredient loaded double encapsulated nanofibers;
c. mixing the 2^{nd} active ingredient and 1^{st} active ingredient loaded crosslinked EC nanoparticles in the solution of gelatin-nanoclay to obtain double encapsulated nanofibers;
d. preparing cross-linked gelatin-nanoclay nanofibers by treating the double encapsulated nanofibers with a specific amount of crosslinkers to obtain the final double encapsulated nanocomposite composition.

In another specific aspect, the present disclosure provides a method for preparing herbicide-loaded cross-linked EC-PVA nanoparticles comprising the steps of:
a. providing EC and herbicide or 1^{st} active ingredient,
b. mixing EC and herbicide or 1^{st} active ingredient in dichloromethane (DCM), followed by stirring overnight to obtain EC-herbicide mixture or EC-1^{st} active ingredient mixture,
c. providing PVA solution,
d. slowly adding the EC-herbicide mixture or the EC-1^{st} active ingredient mixture to PVA solution, followed by sonication to obtain dispersed solution,
e. centrifuging the dispersed solution to obtain a pellet,
f. washing the pellet,
g. dispersing the pellet in CaCl₂ solution, followed by cross-linking by stirring to obtain herbicide-loaded cross-linked EC-PVA nanoparticles,
h. washing the herbicide-loaded cross-linked EC-PVA nanoparticles or the 1^{st} active ingredient-loaded cross-linked EC-PVA nanoparticles, followed by drying.

In another specific aspect, the present disclosure provides a method for preparing cross-linked gelatin-Nanoclay nanofibres comprising the steps of:
a. providing gelatin solution and nanoclay,
b. mixing nanoclay in gelatin solution, followed by stirring to obtain homogeneous blend solutions,
c. preparing gelatin-Nanoclay nanofibres by electrospinning method at ambient conditions,
d. preparing cross-linked gelatin-Nanoclay nanofibres by in situ or ex situ methods.

In yet another aspect, the present disclosure provides a method of controlling Striga weed in sugarcane comprising the steps of:
a. providing double encapsulated nanocomposite granules comprising an herbicide for weeding out the Striga, and a growth stimulant for sugarcane; and
b. delivering the double encapsulated nanocomposite granules near the roots of each of the sugarcane plants,
   wherein, the growth stimulant is released initially to induce the growth of sugarcane as well as germination of Striga and then, the herbicide to kill the Striga during the emergence.

### DETAILED DESCRIPTION OF THE DRAWINGS

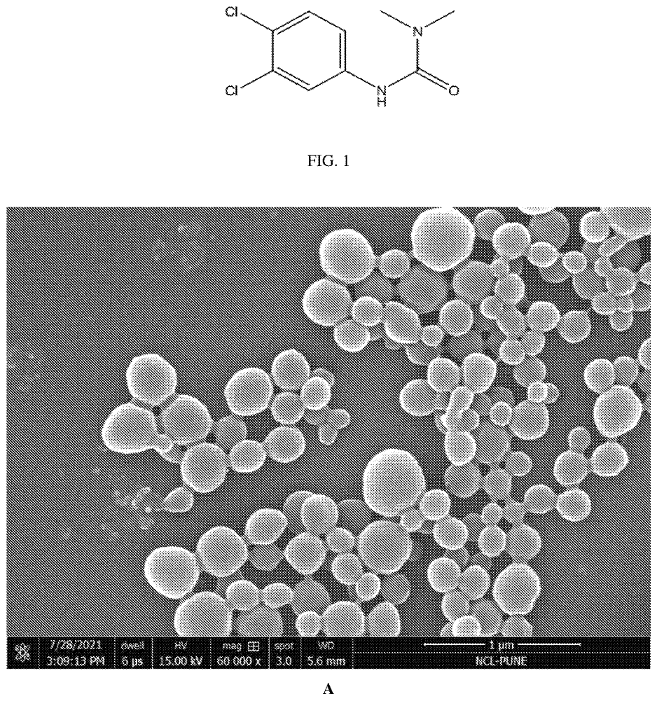

FIG. 1 depicts the Chemical structure of diuron (1^{st} active ingredient).

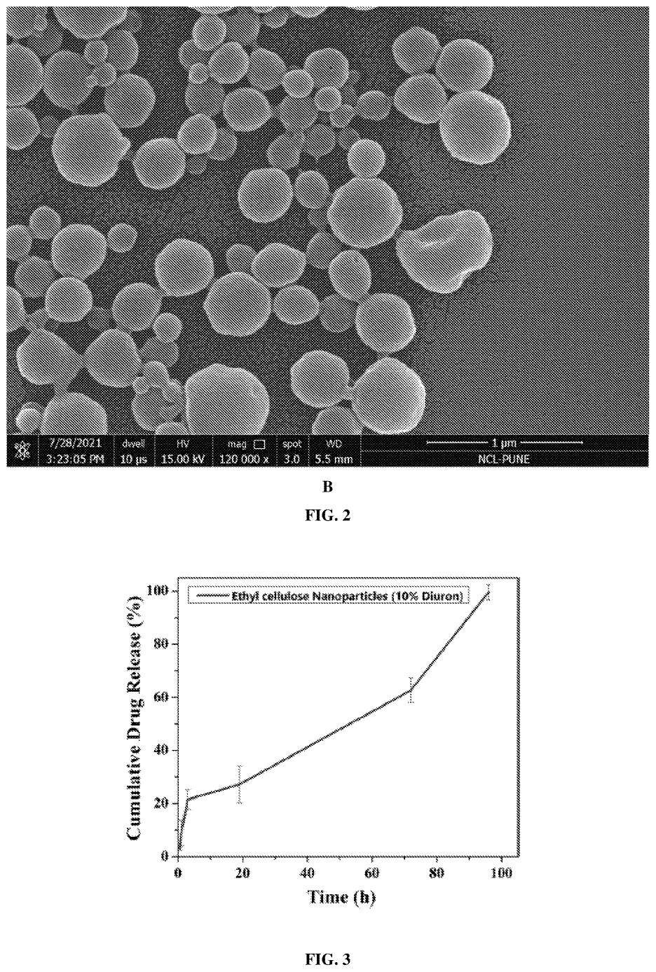

FIGS. 2A and 2B depict the image of EC-PVA nanoparticles and EC-PVA nanoparticles with 10% of Diuron, respectively.

FIG. 3 depicts the in-vitro release profile of diuron loaded EC nanoparticles in the solvent system distilled ethanol:DI water (1:10 v/v).

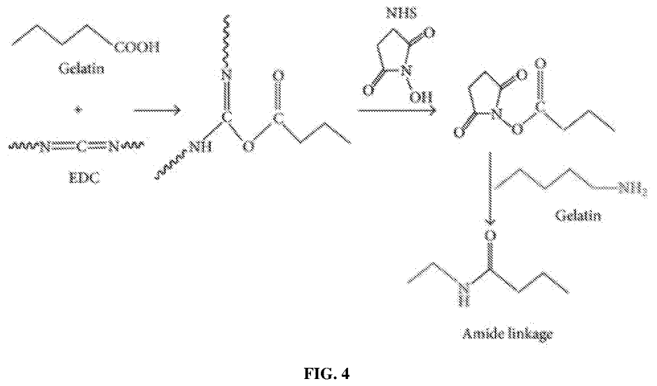

FIGS. 4, 5 and 6 depicts the Mechanism of crosslinking of Gelatin nanofibers via. EDC/NHS coupling reaction; Mechanism of crosslinking of Gelatin nanofibers via. Squaric acid as cross-linker; and Mechanism of crosslinking of Gelatin nanofibers via. Irgacure 2959 as photo cross-linker, respectively.

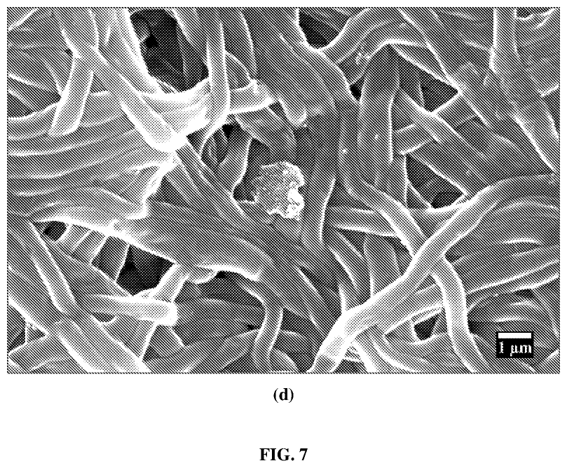

FIG. 7 (a-d) depicts the Representative field emission scanning electron microscopy (FE-SEM) micro-graphs of GH3, G2500 with halloysite nanoclay (3% w/w of gelatin) nanofibers incorporated with Cross-linked EC-PVA nanoparticles (30% w/w of gelatin) loaded with 10% (w/w of EC) of diuron and cross-linked via EDC-NHS coupling for 30 minutes, 1 hour, 2 hours & 4 hours respectively.

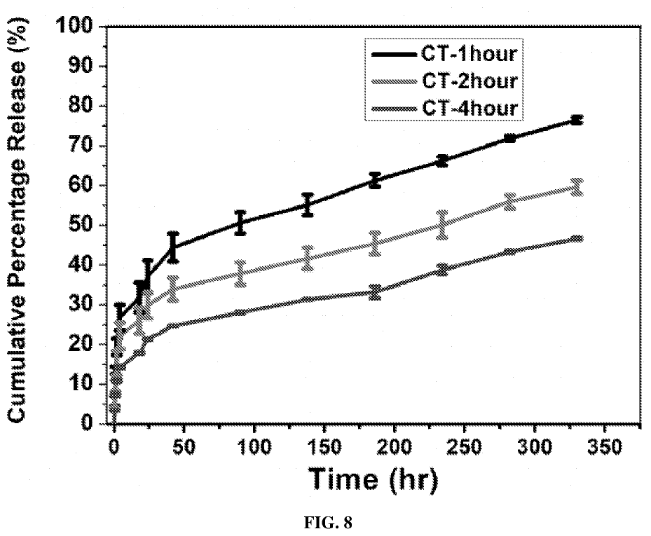

FIG. 8 depicts the in-vitro release profiles of diuron from EC nanoparticles incorporated into time dependent cross-linked GH3 nanofibers in the solvent system distilled ethanol:DI water (1:10 v/v).

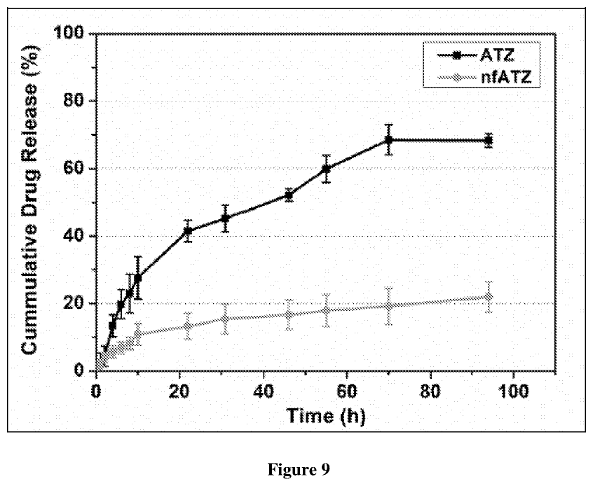

FIG. 9 shows in vitro release kinetics profile of plain atrazine (ATZ) and EC Nps loaded with 10% w/w atrazine (nfATZ).

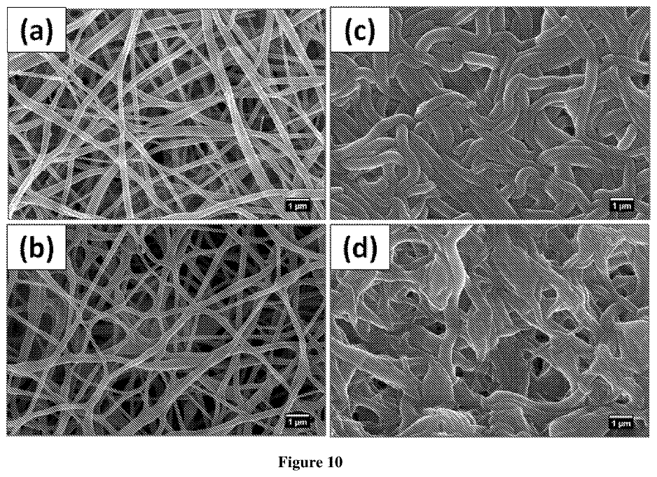

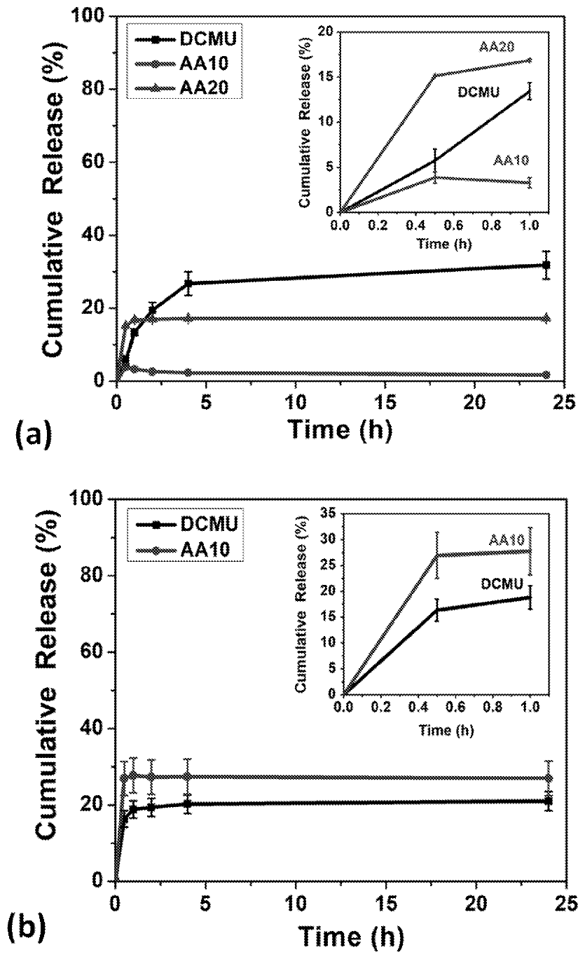

FIG. 10 shows FESEM micrographs of GH3 composite nanofibers incorporated with (a) ascorbic acid (AA) and (b) with both AA & diuron loaded EC Nps [uncross-linked]; (c) and (d) describes the respective morphologies of cross-linked GH3 composite nanofibers via EDC-NHS coupling mechanism for 1 hour reaction time.

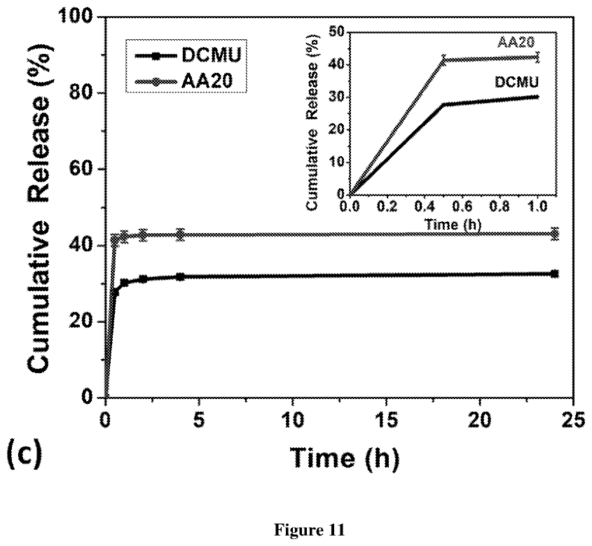

FIG. 11 shows comparison of release profile of AA & DCMU from (a) Controls: GA10ECD0, GA20ECD0 & GA0ECD30; (b) GA0ECD30; & (c) GA20ECD30 respectively in DI water.

### DETAILED DESCRIPTION OF THE INVENTION

The invention will now be described in detail in connection with certain preferred and optional embodiments, so that various aspects thereof may be more fully understood and appreciated.

The terms “the cross-linked EC nanoparticles” and “the cross-linked EC-PVA nanoparticles” are used herein interchangeably with the same meaning.

No biological material has been used in the present invention.

Embodiments of the present invention relate to a carrier system for agrochemicals. Specifically, the present invention relates to a carrier system based on nanocomposites for staged delivery of a plant growth stimulant and an herbicide for controlling weed. The encapsulation of active ingredients is designed in such a way that growth stimulant is released initially to induce the plant growth as well as germination of weed and then, the herbicides to kill the weed during the emergence.

In an embodiment, the present disclosure provides double encapsulated nanocomposite granules for staged delivery of active ingredient(s) (e.g., a plant growth stimulant and an herbicide for controlling weed).

In an embodiment, the present disclosure provides a double encapsulated nanocomposite granules comprising:
a. Cross-linked Ethyl cellulose (EC)-PVA nanoparticles,
b. 1^{st} active ingredient within the Cross-linked EC-PVA nanoparticles, which is 1^{st} active ingredient-loaded cross-linked EC-PVA nanoparticles,
c. cross-linked gelatin-Nanoclay nanofibers with or without 2^{nd} active ingredient, and
d. 1^{st} active ingredient-loaded cross-linked EC-PVA nanoparticles within a mat comprising of cross-linked gelatin-Nanoclay nanofibers with or without 2^{nd} active ingredient to form double encapsulated nanocomposite granules.

In another embodiment, the 1^{st} active ingredient and 2^{nd} active ingredient are same or different, selected from herbicides, plant growth stimulators, nutrients, plant disease controlling agents, antibiotics, nucleic acids, or mixtures thereof.

In another embodiment, the present disclosure provides a method for producing double encapsulated nanocomposite granules for staged delivery of a growth stimulant as 2^{nd} active ingredient and an herbicide as 1^{st} active ingredient for controlling the weeds.

In another embodiment, the present disclosure provides a method for producing double encapsulated nanocomposite granules comprises the steps of:
a. Preparing ethyl cellulose (EC) nanoparticles using PVA in presence of active ingredient, followed by crosslinking the nanoparticles using CaCl₂ to obtain 1^{st} encapsulation of active ingredient, that is 1^{st} herbicide-loaded cross-linked EC-PVA nanoparticles;
b. Preparing cross-linked gelatin-Nanoclay nanofibers by treating nanofibers with specific amount of crosslinkers;
c. optionally mixing 2^{nd} active ingredient with cross-linked gelatin-Nanoclay nanofibers; and
d. mixing cross-linked gelatin-Nanoclay nanofibres with 1^{st} active ingredient-loaded cross-linked EC-PVA nanoparticles to obtain final double encapsulated nanocomposite granules.

In another embodiment of the present disclosure, the double encapsulated nanocomposite granules comprise:
a. Cross-linked Ethyl cellulose (EC)-PVA nanoparticles,
b. Herbicide within the Cross-linked EC-PVA nanoparticles, which is herbicide-loaded cross-linked EC-PVA nanoparticles,
c. cross-linked gelatin-Nanoclay nanofibers with or without growth stimulants, and
d. herbicide-loaded cross-linked EC-PVA nanoparticles within a mat comprising of cross-linked gelatin-Nanoclay nanofibers to form double encapsulated nanocomposite granules, wherein, the double encapsulated nanocomposite granules are arranged in such way that growth stimulant is released initially to induce the germination of Striga, followed by controlled release of herbicide for longer periods to weed out the germinated Striga.

As disclosed herein, the term “controlled release” when used to refer to a carrier system arranged to release one or more agrochemical agents including growth stimulant and/or herbicide of the double encapsulated nanocomposite granules gradually over time. In some embodiments, the carrier system is arranged to release one or more agrochemical agents into medium surrounding the double encapsulated nanocomposite granules, for example, the root development zones of sugar cane, over a period of at least about one week when the root development zones are swelled. In some embodiments, the unit is arranged so as to release a double encapsulated nanocomposite granules over a period of 4 weeks, 3 months, or up to 8 months, and most preferably over the period of time of a growing season of a crop. “Controlled release” is also known by the term “slow release” (“SR”).

As disclosed herein, the term “active ingredient(s)” refers to actives/material/substance having some therapeutic activity, selected from but not limited to herbicides, plant growth stimulators, nutrients, plant disease controlling agents, antibiotics, nucleic acids, and so on.

In some embodiments, the double encapsulated nanocomposite granules enable the delivery of the growth stimulant initially and the herbicide later. In an embodiment, the growth stimulant is substantially released until about 1, 2, 3, 4, 5, 6, 7, 8, 9, 10, 15, 20, 25, >100 days following application to planting soil and substantially increasing the growth. In an embodiment, the herbicide is substantially not released until after about 10, 15, 20, 25, 30 or >100 days following application to planting soil. In some embodiments, the herbicide is released from the granules from a period of at least about 4 weeks until about 5, 6, 7, 8-, 9-, 10-, or 20-weeks following application to planting soil and substantially weeding out Striga.

In some embodiments of present invention, the “nanoparticles” have sizes ranging in nanometer scale. In some embodiments, the nanoparticles may have a diameter of at least about 1 nm, 10 nm, 50 nm, 100 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2500 nm, 3000 nm, 4000 nm, 5000 nm, 6000 nm, 7000 nm, 8000 nm, or at least 9000 nm. In some embodiments, the nanoparticles may have a diameter of less than 10,000 nm, 9000 nm, 8000 nm, 7000 nm, 6000 nm, 5000 nm, 4500 nm, 4000 nm, 3500 nm, 3000 nm, 2500 nm, 2000 nm, 1900 nm, 1800 nm, 1700 nm, 1600 nm, 1500 nm, 1400 nm, 1300 nm, 1200 nm, 1100 nm, 1000 nm, 900 nm, 800 nm, 700 nm, 600 nm, 500 nm, 250 nm, or less than 100 nm. The diameter of nanoparticles can range from any of the minimum values described above to any of the maximum values described above, for example from 1 nm to 10,000 nm, 50 nm to 5,000 nm, 100 nm to 2500 nm, 200 nm to 2000 nm, or 500 nm to 1000 nm. Preferably, the size of the nanoparticles ranges from about 50 nm to about 500 nm. Most preferably 150 nm to 300 nm.

In some embodiments of the present invention, the “nanocomposite granules” have sizes ranging in the nanometer scale. In some embodiments, the nanocomposite granules may have a diameter of at least about 1 nm, 10 nm, 50 nm, 100 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2500 nm, 3000 nm, 4000 nm, 5000 nm, 6000 nm, 7000 nm, 8000 nm, or at least 9000 nm. In some embodiments, the nanoparticles may have a diameter of less than 10,000 nm, 9000 nm, 8000 nm, 7000 nm, 6000 nm, 5000 nm, 4500 nm, 4000 nm, 3500 nm, 3000 nm, 2500 nm, 2000 nm, 1900 nm, 1800 nm, 1700 nm, 1600 nm, 1500 nm, 1400 nm, 1300 nm, 1200 nm, 1100 nm, 1000 nm, 900 nm, 800 nm, 700 nm, 600 nm, 500 nm, 250 nm, or less than 100 nm. The diameter of nanoparticles can range from any of the minimum values described above to any of the maximum values described above, for example from 1 nm to 10,000 nm, 50 nm to 5,000 nm, 100 nm to 2500 nm, 200 nm to 2000 nm, or 500 nm to 1000 nm. Preferably, the size of the nanocomposite granules ranged from about 1 nm to about 500 nm. Most preferably 30 to 70 nm.

In an embodiment of the present disclosure, the herbicide is selected from but not limited to a triazine herbicide, a chloroacetamide herbicide, a 2,6-dinitroaniline herbicide, aclonifen, which is 2-chloro-6-nitro-3-phenoxyaniline; diuron, which is 3-(3,4-dichlorophenyl)-1,1-dimethylurea; and a hydroxybenzonitrile herbicide, 2,4-D, aminopyralid, atrazine, clopyralid, dicamba, glufosinate ammonium, fluazifop, fluroxypyr, imazapyr, imazamox, metolachlor, pendimethalin, picloram, triclopyr, mesotrione, glyphosate, and the like. Preferably diuron, which kills the weed by inhibiting the electron transport chain of photosynthesis.

In an embodiment of the present disclosure, the growth stimulant is selected from but not limited to growth hormones, growth promoting agents such as strigol, Orobanchol, GR24 (synthetic strigolactone), epi-GR24 (synthetic strigolactone), 5-(4-chlorophenoxy)-3-methylfuran-2 (5H)-one (CPMF), and the like.

In one embodiment, the present disclosure provides a method for producing double encapsulated nanocomposite granules for staged delivery of a plant growth stimulant and an herbicide for controlling weed.

In some embodiments of the present disclosure, a method for producing double encapsulated nanocomposite granules comprises the steps of:
a. Preparing ethyl cellulose (EC) nanoparticles using PVA in presence of herbicide, followed by crosslinking the nanoparticles using CaCl₂ to obtain 1^{st} encapsulation of herbicide, that is 1^{st} herbicide-loaded cross-linked EC-PVA nanoparticles;
b. Preparing cross-linked gelatin-Nanoclay nanofibers by treating nanofibers with specific amount of crosslinkers;
c. optionally mixing growth stimulants with cross-linked gelatin-Nanoclay nanofibers;
d. mixing cross-linked gelatin-Nanoclay nanofibres with 1^{st} herbicide-loaded cross-linked EC-PVA nanoparticles to obtain final double encapsulated nanocomposite granules.

In one embodiment, the present disclosure relates to a method for preparing herbicide-loaded cross-linked EC-PVA nanoparticles comprising the steps of:
a. providing EC and herbicide,
b. mixing EC and herbicide in dichloromethane (DCM), followed by stirring overnight to obtain EC-herbicide mixture,
c. providing PVA solution,
d. slowly adding the EC-herbicide mixture to PVA solution, followed by sonication to obtain dispersed solution,
e. centrifuging the dispersed solution to obtain a pellet,
f. washing the pellet,
g. dispersing the pellet in CaCl2 solution, followed by cross-linking by stirring to obtain herbicide-loaded cross-linked EC-PVA nanoparticles,
h. washing the herbicide-loaded cross-linked EC-PVA nanoparticles, followed by drying.

In one embodiment of the present disclosure, the PVA is 0.1% PVA dissolved in water.

In one embodiment of the present disclosure, the EC is 10% EC dissolved in DCM.

In one embodiment of the present disclosure, the amount of herbicide for preparing herbicide-loaded cross-linked EC-PVA nanoparticles ranges from about 1% w/v to 20% w/v with respect to the weight of EC. For example, 1% w/v, 2% w/v, 3% w/v, 4% w/v, 5% w/v, 6% w/v, 7% w/v, 8% w/v, 9% w/v, 10% w/v, 11% w/v, 12% w/v, 13% w/v, 14% w/v, 15% w/v, 16% w/v, 17% w/v, 18% w/v, 19% w/v, or 20% w/v. Preferably 10% w/v with respect to the weight of EC.

In one embodiment of the present disclosure, the ratio of EC+herbicide and PVA is 1:4.

In one embodiment of the present disclosure, the concentration of CaCl2 for preparing herbicide-loaded cross-linked EC-PVA nanoparticles ranges from about 0.2% w/v to 10% w/v. For example, 0.2% w/v, 0.5% w/v, 1% w/v, 1.5% w/v, 2% w/v, 2.5% w/v, 3% w/v, 3.5% w/v, 4% w/v, 4.5% w/v, 5% w/v, 5.5% w/v, 6% w/v, 6.5% w/v, 7% w/v, 7.5% w/v, 8% w/v, 8.5% w/v, 9% w/v, 9.5% w/v, or 10% w/v. Preferably 2% w/v.

In one embodiment, the present disclosure relates to a method for preparing cross-linked gelatin-Nanoclay nanofibres comprising the steps of:
a. providing gelatin solution and nanoclay,
b. mixing nanoclay in gelatin solution, followed by stirring to obtain homogeneous blend solutions,
c. preparing gelatin-Nanoclay nanofibres by electrospinning method at ambient conditions,
d. preparing cross-linked gelatin-Nanoclay nanofibres by in situ or ex situ methods.

In an embodiment of the present disclosure, the nanoclay is selected from but not limited to Halloysite nanoclay.

In one embodiment of the present disclosure, the gelatin solution for preparing cross-linked gelatin-Nanoclay nanofibres comprises of gelatin dissolved in water in an amount range from about 1% w/v to 20% w/v. For example, 1% w/v, 2% w/v, 3% w/v, 4% w/v, 5% w/v, 6% w/v, 7% w/v, 8% w/v, 9% w/v, 10% w/v, 11% w/v, 12% w/v, 13% w/v, 14% w/v, 15% w/v, 16% w/v, 17% w/v, 18% w/v, 19% w/v, or 20% w/v. Preferably 15% w/v. The gelatin solution is further solubilized with DCM.

In one embodiment of the present disclosure, the amount of nanoclay for preparing cross-linked gelatin-Nanoclay nanofibres ranges from about 0.5% w/v to 10% w/v with respect to the weight of gelatin. For example, 0.5% w/v, 1% w/v, 1.5% w/v, 2% w/v, 2.5% w/v, 3% w/v, 3.5% w/v, 4% w/v, 4.5% w/v, 5% w/v, 5.5% w/v, 6% w/v, 6.5% w/v, 7% w/v, 7.5% w/v, 8% w/v, 8.5% w/v, 9% w/v, 9.5% w/v, or 10% w/v. Preferably 3% w/v.

When present, the amount of growth stimulant present in the cross-linked gelatin-Nanoclay nanofibres ranges from about 0.5% w/v to 15% w/v with respect to the weight of gelatin. For example, 0.5% w/v, 1% w/v, 1.5% w/v, 2% w/v, 2.5% w/v, 3% w/v, 3.5% w/v, 4% w/v, 4.5% w/v, 5% w/v, 5.5% w/v, 6% w/v, 6.5% w/v, 7% w/v, 7.5% w/v, 8% w/v, 8.5% w/v, 9% w/v, 9.5% w/v, or 10% w/v. Preferably 3% w/v.

For the fabrication of gelatin-Nanoclay nanofibres by electrospinning at ambient conditions, the homogeneous gelatin-Nanoclay nanofibres solution is filled in a syringe, equipped with a stainless-steel hypodermic needle with a blunt end with a fixed pore. The filled syringe is then mounted on the syringe pump of the electrospinning unit. A high-voltage generator operated in a positive DC mode is connected to the syringe needle, and an aluminum plate was set in a closed chamber to ground the nanofibers. In one embodiment of the present disclosure, the ambient conditions for electrospinning includes a distance between the tip of the needle and the collector of 12 cm, the voltage of 15 kV, and the flow rate of 0.3 mL/h.

In one embodiment of the present disclosure, the in-situ method of preparing cross-linked gelatin-Nanoclay nanofibres is affected by incorporating a cross-linker directly into the gelatin solution for cross-linking and then fabricating it into nanofibers.

In one embodiment of the present disclosure, by varying the time duration of crosslinking reaction, the herbicide-release profile of the cross-linked gelatin-Nanoclay nanofibres is finetuned to achieve a slow and sustained release profile.

In another embodiment of the present disclosure, the ex-situ method of preparing cross-linked gelatin-Nanoclay nanofibres is affected by dipping the nanofibers from step c) into a solution of cross-linker.

In one embodiment of the present disclosure, the cross-linker is selected from but not limited to EDC-NHS (zero length cross-linker), squaric acid (SQ) (non-zero length cross-linker) and Irgacure 2959 (photo-initiator cross-linker), and the like.

EDC-NHS cross-linking: EDC-NHS cross-linking is affected by the reaction of EDC (1-ethyl-3-(3-dimethylamino propyl) carbodiimide hydrochloride) with the carboxylic groups of aspartic and glutamic residues of gelatin molecule forming an intermediate (O-acylisourea) that undergoes nucleophilic attack by the amine lysine residues of gelatin to form amide bonds between the gelatin polymer chains (FIG. . . . ). NHS can be added to the reaction to prevent the O-acylisourea intermediate hydrolysis. EDC/NHS can be prepared using acetonitrile as a solvent.

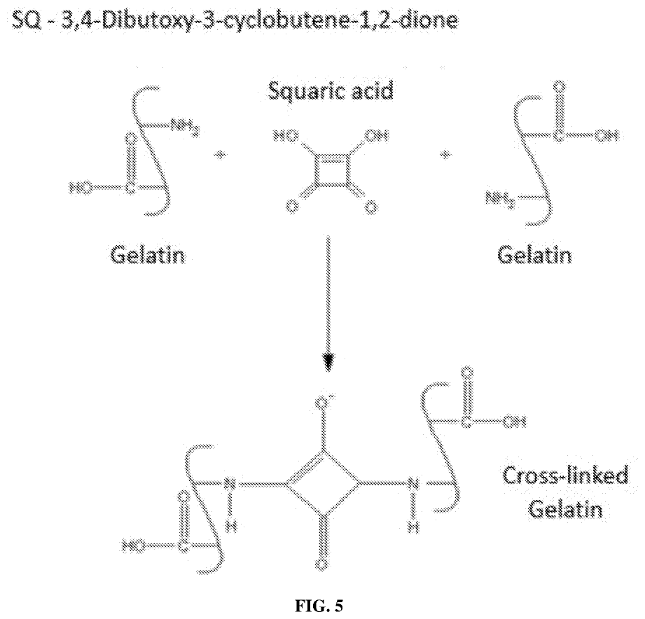

SQ cross-linking: Squaric acid (3,4-dihydroxy 3-cyclobutene 1,2-dione) is a molecule with a cyclic, symmetrical, planar, and rigid structure which is highly acidic and exists in keto-enol balance. The negative charges are evenly distributed in the molecule between the oxygen atoms in a completely symmetrical dianion (FIG. 5). Therefore, it reacts readily with amino groups and may be incorporated into the polymer network. Since, both SQ & gelatin are hydrophilic, SQ cannot be incorporated in vivo for cross-linking. Thus, a suitable organic solvent is required which can dissolve SQ without affecting gelatin nanofibers morphology. Various solvents were tried out for solubilizing SQ, such as, acetonitrile, triethylamine (TEA), diethyl ether (DEE), dichloromethane (DCM), dimethylformamide (DMF), acetone, tetrahydrofuran (THF), and the like. Out of these solvents, SQ was found to be sprangly soluble in dimethylformamide, acetone and tetrahydrofuran but it was also found that the gelatin nanofibers were dissolving in DMF and acetone. Thus, tetrahydrofuran (THF) was chosen as solvent for SQ solubilization.

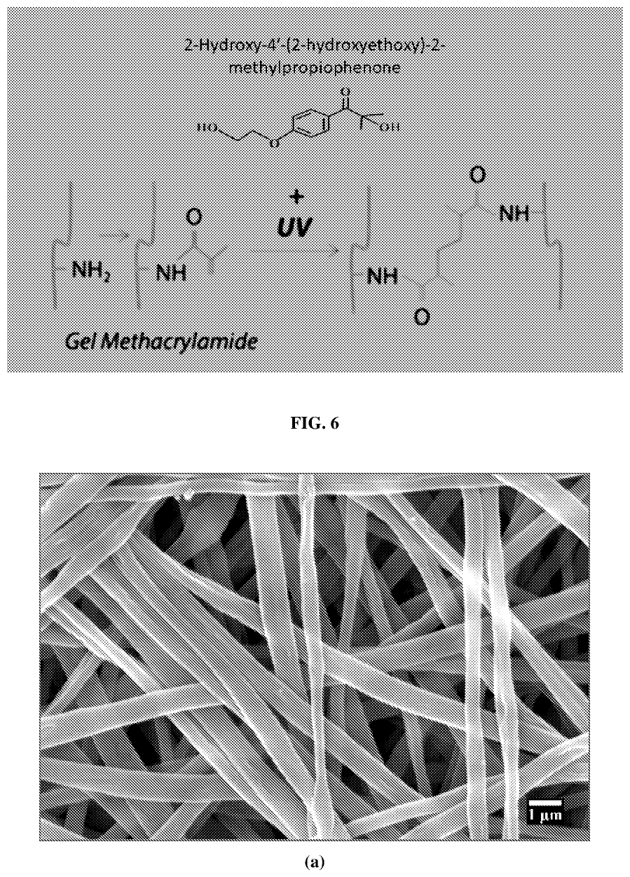

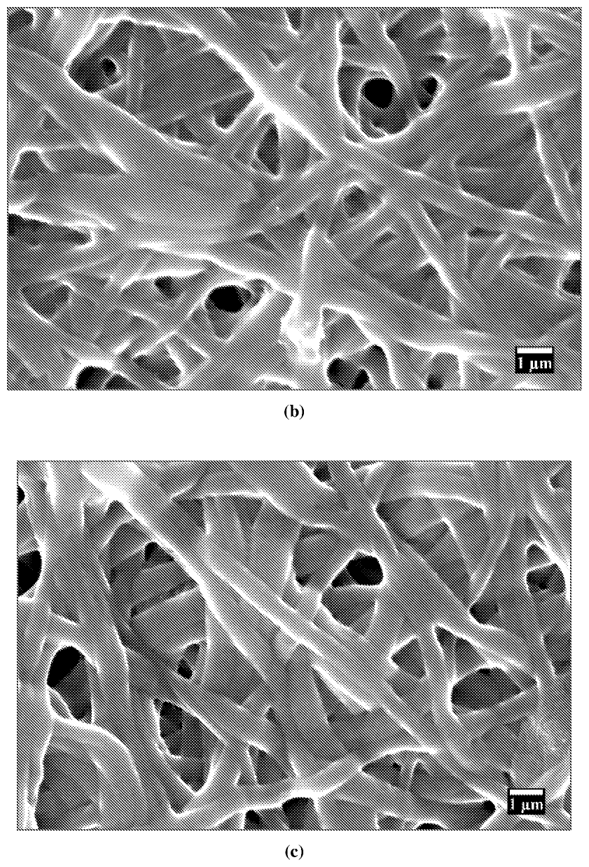

Irgacure 2959 cross-linking: Irgacure 2959 (12959) (2-hydroxy-1-(4 (hydroxyethoxy)phenyl)-2-methyl-1-propanone) is a photoinitiator which is a UV light-sensitive reagent that when exposed to a UV light will dissociate into free radicals that in turn induce the photopolymerization of the polymer (FIG. 6). 12959 is the preferred cross-linker due to its high free radical generation efficiency and relatively higher water solubility.

For preparing double encapsulated nanocomposite granules, the amount of herbicide-loaded cross-linked EC-PVA nanoparticles with respect to the cross-linked gelatin-Nanoclay nanofibres is in an amount ranging from about 10% wt. to 50% wt. For example, 10% wt., 15% wt., 20% wt., 25% wt., 30% wt., 35% wt., 40% wt., 45% wt., or 50% wt. Preferably 30% wt.

In another embodiment, the present disclosure provides a method of controlling Striga weed in sugarcane comprising the steps of:
c. providing double encapsulated nanocomposite granules comprising a growth stimulant for Striga and a herbicide for weeding out the same;
d. delivering the double encapsulated nanocomposite granules near the roots of each of the sugarcane plants,
   wherein, the growth stimulant is released initially to induce the germination of Striga and then, the herbicides to kill the same during the emergence.

### EXAMPLES

The following examples, which include preferred embodiments, will serve to illustrate the practice of this invention, it being understood that the particulars shown are by way of example and for purpose of illustrative discussion of preferred embodiments of the invention.

### Procurement Details and Abbreviations Used

1. Polyvinyl alcohol (PVA): S D Fine, Mol. Wt. approx. 125000 LR grade
2. Ethyl cellulose: S D Fine, Mumbai, India (Ethoxy content 44-51%, Viscosity of 5% w/w 18-24 mPas)
3. Diuron: Sigma Aldrich, Bangalore, India (Made in Germany)
4. DCM: Finar AR grade dry solvent, Gujrat, Ahmedabad, India
5. CaCl₂: Thomas Baker, Fused LR grade, Mumbai, India
6. MeOH: Rankem HPLC grade, Avantor Performance Material India Ltd., Thane, Maharashtra, India
7. Sodium azide: Thomas Baker, AR grade, Mumbai, India
8. Gelatin: Sigma Aldrich, Bangalore, India (Made in USA)
9. N, N-dimethyl acetamide (DMA): Sisco Research Laboratories Pvt. Ltd., Mumbai, India
10. Halloysite nanoclay: Sigma Aldrich, Mumbai, India (Made in USA)
11. EDC [(1-ethyl-3-(3-dimethylamino propyl) carbodiimide]: Sigma Aldrich, Mumbai, India
12. NHS (N-hydroxy succinimide): SD Fine, LR grade, Mumbai, India
13. Squaric acid (3,4-dihydroxy 3-cyclobutene 1,2-dione): Alfa Aesar Thermo Fisher Scientific, Heysham, (Made in China)
14. Irgacure 2959 [1295 or (2-hydroxy-1-(4 (hydroxyethoxy)phenyl)-2-methyl-1-propanone)]: Sigma Aldrich, Mumbai, India
15. G2500 nanofibers: Plain gelatin (Bloom No. 300, Sigma Aldrich) nanofibers
16. G nanofibers: G2500 nanofibers with 0% (w/w wrt gelatin) halloysite nanoclay
17. GH1 nanofibers: G2500 nanofibers with 1% (w/w wrt gelatin) halloysite nanoclay
18. GH3 nanofibers: G2500 nanofibers with 3% (w/w wrt gelatin) halloysite nanoclay

### Example 1: Preparation of Diuron (Herbicide) Loaded EC Nanoparticles (1^{st} Encapsulation)

4 mL of 0.1% polyvinyl alcohol (PVA) in water was taken in a 10 mL of glass vial and 1 mL of EC (10%) and 10% of diuron (FIG. 1) (with respect to weight of EC) was dissolved in DCM and kept overnight (10 hours) for stirring. Later it was added to the PVA solution in dropwise manner for 15 minutes. The resultant mixture was sonicated (probe sonicator) for 30 minutes (if heat generates, ice bath required). After 30 minutes, the dispersed solution was stirred for 2 hours then centrifuged at 10000 rpm for 15 minutes. The supernatant of the solution was used for diuron estimation in UV spectrophotometer. Later, the pellet was washed with distilled water (3 mL) for 5 times and the pellet was dispersed in 2% of CaCl₂ solution (3 ml) and crosslinked by stirring at room temperature for 6 hours. After crosslinking of the EC nanoparticles, the nanoparticles were washed with distilled water (30 mL) for 5 times. The resultant EC nanoparticles were dried at room temperature (25° C.) for 24 hours.

A) FESEM Analysis: Field emission scanning electron microscopy (Nova NanoSEM 450, FEI, USA) was used to analyze the surface morphology of EC nanoparticles. The nanoparticle samples were prepared by cutting a small portion of silicon wafer and mounting on SEM stub using double coated carbon tape and then drop casting the liquid dispersion of nanoparticles over the wafer and then drying at room temperature. The mounted stub was sputtered with gold using an E5000 coating unit (Polaron Equipment Ltd., Watford, Hertfordshire, England, UK). A dual beam, having an electron source of tungsten filament (W) with emission at resolution of 15 kV in high vacuum, was used for the studies.

TABLE 1
Size of Cross-linked EC-PVA nanoparticles with and
without diuron loading. Data displayed as mean ± SD.

| Formulations | Diameter (nm) |
|---|---|
| Plain Cross-linked EC-PVA | 226 ± 77 |
| nanoparticles | |
| Cross-linked EC-PVA nanoparticles | 295 ± 95 |
| loaded with 10% (w/w) diuron | |

B) Morphology Study: As depicted from the FIGS. 2(A) and 2(B), and the table 1; the morphology of plain EC nanoparticles and EC nanoparticles loaded with 10% (w/w) diuron were nearly spherical in shape. With loading of diuron, the size of EC nanoparticles slightly increases from 226 nm to 295 nm. For accurate size estimations and overall surface charge distribution, further studies such as, DLS and Zeta potential analysis were done.

C) Estimation of size and overall surface charge of plain EC and Diuron loaded EC nanoparticles: The zeta potential and particle size distribution of plain EC nanoparticles and EC nanoparticles loaded with 10% w/w of diuron were analyzed using a 90 Plus Brookhaven Instruments Corp, PALS zeta potential analyzer, USA. For zeta potential, 5 mg of nanoparticles sample was mixed in 4 mL of MeOH: DI water (1:3 v/v) and 750 μL of it were taken in a plastic cuvette. The cuvette was then placed in the zeta potential analyzer for analysis at 25° C. and pH=7.0. For DLS analysis, the nanoparticles sample solution was diluted 100× and 2 mL of the diluted solution was taken inside a fresh plastic cuvette and placed in the instrument and run in DLS mode at 25° C. and 90° deflection.

TABLE 2
Size, PDI and zeta potential of EC nanoparticles and
EC nanoparticles loaded with Diuron. Data displayed
as mean ± SD.

| | | | Zeta |
|---|---|---|---|
| S. | Particles | Particle Size | Potential |
| No. | Name | (nm) (PDI) | (mV) |
| 1 | Cross-linked | 136.3 ± 2.9 | −22.82 ± 0.98 |
| | EC-PVA | (0.101) | |
| | nanoparticles | | |
| 2 | EC + 10% | 112.3 ± 4.6 | −25.59 ± 1.83 |
| | Diuron Nps | (0.304) | |

The hydrodynamic size and distribution of the formulated EC and atrazine loaded EC nanoparticles were in the range of 130-140 and 100-120 nm diameter, respectively as shown in Table 2. The polydispersity index of the nanoparticles varied from 0.101 (Cross-linked EC-PVA nanoparticles) to 0.304 (Cross-linked EC-PVA nanoparticles with 10% diuron) which is in good agreement that the nanoparticles were uniform in size. The zeta potential varied from −22 (Cross-linked EC-PVA nanoparticles) to −26 (Cross-linked EC-PVA nanoparticles with 10% diuron) which indicates their stability in the MeOH: DI water (1:3 v/v) solvent system. The increase in the potential confirms that the diuron was loaded in the Cross-linked EC-PVA nanoparticles. Also, the negative zeta potential represents that the overall surface charge of the nanoparticles was of anionic nature.

D) Estimation of entrapment efficiency and loading efficiency: A stock of standard solution was prepared at 1.0 mg/mL concentration by dissolving 5.0 mg of Diuron in 5 mL of distilled ethanol and water with 0.1% sodium azide in 9:1 v/v ratio in a 5.0 mL volumetric flask. Then, serial dilutions of the standard solution were prepared in triplicates by diluting the stock solution with same solvent system to obtain seven calibration standard solutions (2.0, 3.0, 4.0, 5.0, 6.0, 7.0, and 8.0 μg/mL). All standard solutions were kept in vials at room temperature until further analysis. The standard curve of Diuron was prepared by using UV-visible spectroscopy. The Diuron gives maximum absorbance in distilled ethanol at the wavelength of 251.0 nm in UV region of the spectrum, hence, all the standard solutions of known concentrations were analyzed at wavelength of 251.0 nm. The entrapment and loading efficiency of NPs were determined by calculating the unentrapped diuron present in the supernatant which was obtained during the preparation of diuron loaded EC nanoparticles as explained earlier. The unentrapped diuron concentration present in the supernatant was estimated using the standard calibration curve of diuron at λₘₐₓ of 251 nm and was analyzed using a UV-Visible spectrophotometer (UV 1601PC UV spectrophotometer, Shimadzu, Japan). The percent of entrapment efficiency (% EE) and the percent of loading efficiency (% LE) was estimated using eqn. (1), and eqn. (2) respectively.

$$\% EE = \frac{( Wt . of diuron used - Wt . of unentrapped diuron )}{Wt . of diuron used} \times 100 \qquad ( 1 )$$

$$\% LE = \frac{( Wt . of entrapped diuron in Nps )}{Wt . of Nps} \times 100 \qquad ( 2 )$$

TABLE 3
The drug loading efficiency (LE) and encapsulation
efficiency (EE) of diuron-loaded CaCl₂ cross-
linked EC-PVA nanoparticles for batch 1 and
batch 2 preparation.

| | Loading | Encapsulation |
|---|---|---|
| Batch | efficiency | efficiency |
| preparation | (% LE) | (% EE) |
| Batch 1 | 8.60 | 98.04 |
| Batch 2 | 8.56 | 97.62 |

From the table 3, it is observed that both the loading efficiency and encapsulation efficiency are very similar in batch 1 and batch 2 preparations. This shows that the preparation procedure was reproducible.

E) In vitro diuron release study: The release of diuron from the Cross-linked EC-PVA nanoparticles was studied via dispersing 5 mg of with and without diuron loaded Cross-linked EC-PVA nanoparticles (plain Cross-linked EC-PVA nanoparticles and EC NP (diuron 10% w/w)) in 2 mL of distil water with 1% w/v sodium azide and enclosing them in dialysis membrane tubes (Mw cut-off: 12 kDa). These dialysis bags were kept in 18 mL of the same solvent as was inside the dialysis bags and were incubated at 37° C. in a shaker bath (Julabo SW23) at 50 rpm. At regular intervals of time, 1 mL was withdrawn from the solvent and 1 mL of fresh solvent was added to maintain the sink conditions. The withdrawn solvent was analyzed for the amount of diuron released using a UV-vis spectrophotometer at 251 nm. The release behaviour of diuron from cross-linked EC-PVA nanoparticles was depicted in FIG. 3. It shows that diuron loaded cross-linked EC-PVA nanoparticles displays sustained release of herbicide diuron for up to 4 days and the cumulative release obtained after 4 days was about 97%.

### Example 2: Preparation of Atrazine (Herbicide) Loaded EC Nanoparticles (1st Encapsulation)

Atrazine (ATZ, TCI, Pune, India) loaded ethyl cellulose (EC, ethoxy content 44-51%, viscosity of 5% w/w 18-24 mPas, S D Fine-Chem, Mumbai, India) Nps (nfATZ) were prepared by a modified oil-in-water solvent precipitation method. 0.1% w/v polyvinyl alcohol was prepared (PVA, mol. wt. 125000, S D Fine-Chem, Mumbai, India) in water (aqueous phase) and 10% w/v EC with 10% ATZ (w.r.t. weight of EC) was dissolved in dichloromethane (DCM, AR grade dry solvent, Finar, Ahmedabad, India), which was the organic phase. The organic phase was then added to the aqueous phase of the PVA solution with sonication for 30-45 minutes (ice bath was used to contain the heat generation). Later, DCM was removed from the solution by open stirring for 2 hours. The leftover solution was centrifuged at 9000 rpm for 20 minutes. The supernatant was collected to estimate ATZ using a UV spectrophotometer. Finally, the pellet obtained was washed with distilled water (25 mL) for 5 times and dispersed in 2% calcium chloride (CaCl₂, Fused LR grade, Thomas Baker, Mumbai, India) (30 ml). It was allowed to cross-link for 6 hours while stirring at room temperature. After cross-linking, the Nps were washed again with distilled water (30 mL) for 5 times and dried at room temperature (25° C.) for 24 hours. ATZ-free Nps (nf) were also prepared following the same procedure with an organic phase containing only EC.

The loading efficiency and encapsulation efficiency were estimated by an indirect method of finding the amount of unentrapped ATZ using a calibration curve prepared at λₘₐₓ of 223 nm. The loading efficiency (LE) and encapsulation efficiency (EE) of the nfATZ were between 7.5% to 8.5% and 85% to 96%, respectively (Table 4).

TABLE 4
The drug loading efficiency (LE) and encapsulation
efficiency (EE) of the nano-formulation (nfATZ)
for batch 1 and batch 2 preparation

| | Loading | Encapsulation |
|---|---|---|
| Batch | efficiency | efficiency |
| preparation | (% LE) | (% EE) |
| Batch 1 | 7.58 | 86.38 |
| Batch 2 | 8.42 | 95.98 |

A) Characterization: The morphology and size distribution of the nf and nfATZ were observed using a field emission scanning electron microscope (FE-SEM; Nova NanoSEM 450, FEI, Hillsboro, USA) and a high-resolution transmission electron microscope (HR-TEM; Tecnai TF20, 200 kV FEG, FEI, Hillsboro, USA). The ζ-potential and particle size distribution of nf and nfATZ were estimated using a PALS zeta potential analyzer (Brookhaven Instruments, Holtsville, USA). The material structural analysis was determined using a Fourier transform infrared spectrometer (FTIR; PerkinElmer, Waltham, USA) and X-ray diffractometer (XRD; PANalytical X'Pert PRO, Malvern Panalytical, Malvern, UK). The interaction between ATZ and EC was analyzed using differential scanning calorimetry (DSC). Thermal gravimetric analysis (TGA) was carried out using a Simultaneous Thermal Analyzer (STA) 6000 (PerkinElmer, Waltham, USA) operating under N₂ with a flow rate of 50 mL min⁻¹ and a temperature from 50 to 900° C. with a heating rate of 10° C. min⁻¹.

The nf and nfATZ morphology were studied using SEM and TEM analyses. The morphology of the nf and nfATZ were nearly spherical but polydispersed. With the loading of ATZ, the size of EC Nps decreases from 144 nm to 85 nm, as evident from Table 5. The DLS and Zeta (ζ) potential analysis were performed for accurate size estimations and overall surface charge distribution.

TABLE 5
Size of EC Nps (nf) and EC Nps loaded with
10% w/w ATZ (nfATZ) as depicted from
FE-SEM analysis

| | Diameter |
|---|---|
| Formulations | (nm) |
| Nf | 98 to 144 |
| nfATZ | 71 to 85 |

Table 6 shows the hydrodynamic size, polydispersity, and ζ-potential of the nf and nfATZ. The size of the nf and nfATZ were in the range of 100-145 and 70-85 nm in diameter, respectively, which are in good agreement with the SEM data. The polydispersity index of the Nps varied from 0.101 (nf) to 0.298 (nfATZ), which indicate that the Nps were of uniform size. The ζ-potential is a parameter that can be used to evaluate the stability of colloidal systems. The measured ζ-potential values reflected the charges on the particles. In contrast, the stability of the particles was related to steric hindrance caused by the presence of PVA adsorbed on the surfaces of Nps and not by the surface charge. The ζ-potential varied from −22 (EC Nps) to −39 (EC Nps with 10% ATZ), which indicates their stability in the MeOH: DI water (1:3 v/v) solvent system. Also, the negative ζ-potential represents that the overall surface charge of the Nps was of an anionic nature.

TABLE 6
Size, PDI, and ζ-potential of EC Nps (nf) and EC Nps
loaded with 10% w/w ATZ (nfATZ). Data displayed
as mean ± SD.

| Particle | Particle Size | ζ potential |
|---|---|---|
| Name | (nm) (PDI) | (mV) |
| EC Nps | 136.3 ± 2.9 (0.101) | −22.82 ± 0.98 |
| EC Nps + | 108.6 ± 0.7 (0.298) | −39.46 ± 0.57 |
| 10% ATZ | | |

The FTIR spectrum of ATZ shows a band at 3255 cm⁻¹ corresponding to stretching of the N—H bond present in the amine functional group of ATZ. The band at 2977 cm⁻¹ was associated with the stretching of the alkyl group C—H bond. The FTIR spectrum of EC showed the characteristic bands at 2977 cm⁻¹ and 2869 cm⁻¹ due to C—H stretching and vibration, and the —OH stretching and vibration peak was observed at 3425 cm⁻¹. The other important peaks at 1053 cm⁻¹ and 1373 cm⁻¹ corresponded to C—O—C stretching and C—H bending, respectively. The peak at 3255 cm⁻¹, corresponding to the stretching of N—H bond present in amine functional group of atrazine, was shifted to 3258 cm⁻¹. The peak at 1542 cm⁻¹, which indicated deformation of C═N bonds, was increased to 1545 cm⁻¹. Likewise, characteristic peaks at 2869 cm⁻¹ due to C—H stretching vibration in EC were enhanced to 2874 cm⁻¹. Thus, these peaks indicate presence of atrazine in polymeric matrix of EC Nps, and slight shift in bands was due to their intermolecular interactions. XRD patterns of EC exhibits two broad peaks at 2θ=8.2° and 19.5°, whose position and intensities shifted slightly (2θ=8.24° and 20.87°) with less intensity when transformed into Nps. These broad peaks of EC indicate that it is semi-crystalline in nature. ATZ being crystalline in nature, various sharp peaks, with high intensity, were observed at 2θ=13.08°, 18.55° and 19.75°. After dispersing ATZ in the EC matrix, EC lost its crystalline nature and became amorphous. This shows that the ATZ was uniformly dispersed in the nano-formulation.

DSC: EC shows T_{g} around 121° C., which is between the T_{g} range, 120° C.-135° C. The nf depicts a shift in T_{g} from 121° C. to 131º° C. This indicates that the inter-chain-chain molecular interaction increased in a compact space and enhances the overall hardness of EC, which may influence the controlled release of ATZ. The herbicide ATZ showed a similar sharp melting endotherm, Tₘ at 181° C., which disappeared after its loading in the nf, implying that ATZ lost its crystallinity due to uniform dispersion in the polymer matrix during the preparation of nano-formulation. The nfATZ recorded a T_{g} at 125° C.; a shift in the T_{g} from 131° C. (nf) was observed because of molecular interaction between the EC matrix and ATZ. All T_{g} transitions were within expected range of T_{g} for pristine EC, as mentioned previously. Thus, there may not be any impact on properties of EC. TGA thermograms and their thermogram derivatives (DTG) of ATZ, pristine EC, nf, and nfATZ: For ATZ, the thermal decomposition temperature was initiated at 230° C. and ended at 298° C., wherein the weight loss was 99%. Two-stage decomposition temperatures were recorded for pristine EC, 50-95° C., due to loss of moisture (weight loss, 2.9%) and 150-380° C. due to fragmentation of chemical bonds (weight loss, 85%). After arriving at the final temperature of 600° C., the total weight loss of EC was 96.59%. For the nf, there was a weight loss of 2.63% between the temperatures 50 to 173° C. due to the evaporation of surface water. The second phase of weight loss was initiated from 335° C. to 600° C., where the total weight loss was 96.84%. From these results, inventors have concluded that there was no change in degradation temperature before and after the fabrication of nf, and the thermal stability was the same as pristine EC. However, with the incorporation of ATZ into nf, the thermal properties were changed. Further, it is observed that nfATZ recorded a broad first derivative peak for the weight loss, which may be due to the merging of two first derivative peaks, one for ATZ and the other for EC. This shows that ATZ has chemically interacted with EC via hydrophobic interactions. Further, it is observed that the maximum degradation temperature of the nfATZ was increased from 230° C. to 265° C. (FIG. 6(b) inset), indicating that they are more stable thermally compared to bulk ATZ.

B) In vitro atrazine release from nanoformulations: A dialysis tubing (MWCO 12 kDa, Sigma-Aldrich, St. Louis, USA) was taken with nfATZ (2 mg), where the total amount of ATZ loaded was 200 μg. In another dialysis tubing, 200 μg of ATZ (bulk form) dispersed in 2 ml of distilled water (DW) with 0.1% w/v sodium azide was taken. These dialysis bags were kept in 18 mL of DW containing sodium azide, and the release studies were done at 37° C. in a shaker bath (SW23, Julabo, Seelbach, Germany) at 50 rpm. At regular intervals, 1 mL of DW was withdrawn and replaced with 1 mL of fresh DW to maintain the sink conditions. The withdrawn DW was analyzed for the amount of ATZ released using a UV-visible spectrophotometer at λₘₐₓ of 222 nm. FIG. 9 shows the ATZ release profile for plain ATZ (bulk) and nanoformulations (nfATZ) in DI water at room temperature (~27° C.). After 94 hours of release studies, 60% of ATZ was released in the case of plain ATZ, while 22% of ATZ was released from the nfATZ. This shows that the rate and extent of release of ATZ from the nfATZ was very slow. From this observation, it is noted that the another 90% of release from the nano-formulation can extend up to 30 days. From these studies, inventors concluded that the nanoformulations is the best choice to control the weeds for an extended period, which can be manipulated as desired by changing concentration of EC and ATZ.

### Example 3: Fabrication of Gelatin (GEL) Nanofibers by Electrospinning (2^{nd} Encapsulation)

Gelatin (GEL) was found to be a suitable candidate since it is hydrophilic in nature and it has various functional groups present in the structure in terms of amino acid backbone, which would help in interacting with EC nanoparticles and delay the release of diuron from them. For this experiment inventors have used Type A gelatin from Sigma Aldrich of high bloom number ~300, G2500. GEL (15% w/v) was prepared by first dissolving calculated amount in water (1 mL) through autoclaving (121° C., 15 min) and was then keeping at 45° C. until mixing. After that, equal volumes of the gelatin solution and N, N-dimethyl acetamide (DMA), a polar organic solvent, were mixed and kept on magnetic stirrer at 45° C. for overnight stirring.

A) Preparation of GEL nanofibers: For the fabrication of GEL nanofibers, the prepared homogeneous GEL solution was filled in a 2 mL syringe, equipped with a stainless-steel hypodermic needle with a blunt end with a fixed pore. The filled syringe was mounted on the syringe pump of the electrospinning unit. A high-voltage generator operated in a positive DC mode was connected to the syringe needle, and an aluminum plate was set in a closed chamber to ground the nanofibers. Electrospinning was done at ambient conditions, and the parameters were optimized to 12 cm, distance between the tip of the needle and the collector, 15 kV, the voltage, and 0.3 mL/h, the flow rate for obtaining GEL nanofiber mats.

B) Preparation of GEL nanofibers loaded with Halloysite nanoclay: Since the obtained gelatin nanofibers were not mechanically strong, inventor added nanoclay to enhance their mechanical strength. Hence, for the fabrication of GEL nanofibers loaded with Halloysite nanoclay, the GEL solution was prepared at 15% w/v concentration as described earlier and then Halloysite nanoclay was added at 1%, 3% and 6% w/w concentrations wrt to GEL content. These solutions were kept for overnight (10 hours) stirring at 45° C. to obtain homogeneous blend solutions. Later, the prepared homogeneous GEL with Halloysite nanoclay solutions were filled in 2 mL syringes, equipped with a stainless-steel hypodermic needle with blunt end of fixed pore. The filled syringe was mounted on the syringe pump of the electrospinning unit. A high-voltage generator operated in a positive DC mode was connected to the syringe needle, and an aluminum plate was set in a closed chamber to ground the nanofibers. Electrospinning was done at ambient conditions, and the parameters were fixed as follows, the distance between the tip of the needle and the collector kept to 12 cm, the voltage fixed to 15 kV, and the flow rate was 0.3 mL/h. The nanofiber mats of GEL loaded with Halloysite nanoclay were collected from the aluminum foils.

TABLE 7
Size of GEL NFs and GEL NFs incorporated with
1% w/w of Halloysite nanoclay. Data
displayed as mean ± SD.

| | Diameter |
|---|---|
| Formulations | (nm) |
| Pure gelatin nanofibers | 124 ± 33 |
| Gelatin nanofibers incorporated with | 202 ± 65 |
| 1% w/w Halloysite nanoclay | |

B) Morphology Study: FIGS. 8(a) and 8(b) demonstrates the FESEM micrographs of plain gelatin nanofibers and gelatin nanofibers incorporated with 1% w/w Halloysite nanoclay. From the figure, it was observed that the existing plain gelatin nanofibers were randomly aligned, beadles, interconnected, continuous and with addition of Halloysite nanoclay their diameter increases from 124 nm to 202 nm. It was also observed that the Halloysite nanoclay was thoroughly mixed with the gelatin solution since there were no aggregates of nanoclay throughout the surface of the nanofibers. The EDX analysis as depicted from FIGS. 8(c) and 8(d), indicates the presence of Halloysite nanoclay in the gelatin nanofibers. Table 8 shows the element percentage found in the nanofibers. The Al and Si percentages were 0.56 and 0.29% respectively for the gelatin nanofibers containing Halloysite nanoclay whereas in case of pure gelatin nanofibers they were 0.16 and 0.08%. This further confirms the presence of Halloysite nanoclay in the nanofibers.

TABLE 8
Elemental analysis of pure gelatin nanofibers and
gelatin nanofibers loaded with 1% (w/w)
Halloysite nanoclay

| Element | G (Wt %) | GH1 (Wt %) |
|---|---|---|
| C | 62.23 | 61.87 |
| N | 19.75 | 18.66 |
| O | 15.34 | 17.18 |
| Al | 00.16 | 00.56 |
| Si | 00.08 | 00.29 |
| P | 01.00 | 00.97 |
| S | 00.30 | 00.24 |
| Cl | 00.14 | 00.23 |

C) Crosslinking of GEL nanofibers loaded with 3% w/w Halloysite nanoclay, GH3: To further improve the stability of these nanofibers, they were cross-linked using two different approaches, in situ and ex situ. In in-situ approach, the cross-linker was directly incorporated into the gelatin solution and then fabricated into nanofibers and exposed to conditions required for cross-linking while in ex-situ approach, the nanofibers were dipped into the solution of cross-linker for cross-linking. For crosslinking 3 kinds of cross-linkers were tried out: EDC-NHS (zero length cross-linker), squaric acid (SQ) (non-zero length cross-linker) and Irgacure 2959 (photo-initiator cross-linker). All the three cross-linkers are highly water soluble and since gelatin is also water soluble and has inherent property of forming gels in presence of water, it is imperative to select organic solvents in which these cross-linkers are sprangly or readily soluble.

D) EDC-NHS cross-linking (FIG. 4): EDC (1-ethyl-3-(3-dimethylamino propyl) carbodiimide hydrochloride) reacts with the carboxylic groups of aspartic and glutamic residues of gelatin molecule forming an intermediate (O-acylisourea) that undergoes nucleophilic attack by the amine lysine residues of gelatin to form amide bonds between the gelatin polymer chains. NHS can be added to the reaction to prevent the O-acylisourea intermediate hydrolysis. The ex vivo approach covers: 50 mM of EDC/NHS (2.5:1 molar ratio) have been prepared using acetonitrile as a solvent. The already prepared gelatin nanofibers mat was dipped in the above solution and kept for 8 h of cross-linking reaction. Later the unreacted solution was removed, and the mat was again washed in acetonitrile solution to remove any unreacted reactants. Then the mat was covered with aluminum foil with holes and kept for air drying for overnight. The in vivo approach was also tried out where the EDC and NHS in the same molar ratio (2.5:1) was added into gelatin solution prior to electrospinning, but was found out that solution starts gelling and not electro-spinnable.

E) Irgacure 2959 cross-linking (FIG. 6): Irgacure 2959 (12959) (2-hydroxy-1-(4 (hydroxyethoxy)phenyl)-2-methyl-1-propanone) is a photoinitiator which is a UV light-sensitive reagent that when exposed to a UV light will dissociate into free radicals that in turn induce the photopolymerization of the polymer. Following ex vivo approach, different concentrations (see Table 6) of 12959 were prepared in acetonitrile. The already prepared GH3 nanofibers mats were dipped in the above solutions in PTFE petri dishes and kept in UV chamber for cross-linking reaction to occur. 3 cycles of 9 minutes and 10 seconds of UV light (365 nm) exposure was given to each surface of the GH3 nanofibers mats. Later the unreacted 12959 solutions were removed from the petri-dishes and the mats were washed with acetonitrile to remove any unreacted reactants. Then the mats were covered with aluminum foil with holes and kept in vacuum oven at 45° C. overnight for drying.

F) Stability check of cross-linked GEL nanofibers loaded with 3% w/w Halloysite nanoclay, GH3: Further, to check the stability of the cross-linked GH3 mats using different concentrations of I2959, small pieces of 1×1 cm² from each cross-linked mats were kept in 1 mL of DI water and observed for the time taken to completely dissolve (refer Table 9).

TABLE 9
Experiments to confirm crosslinking of gelatin
nanofibers loaded with 1% (w/w) Halloysite
nanoclay using I2959 as photoinitiator.

| GH3 Nfs | Observation (time taken |
|---|---|
| (Irgacure | by cross-linked Nfs to |
| 2959 Conc. | dissolve completely in |
| % w/v) | water) |
| 0.01 | Within seconds |
| 0.10 | Within 1 minute |
| 0.50 | After 24 hours of immersion |
| 1.00 | After 48 hours of immersion |
| 1.50 | Sustain its structure till 24 |
| | hours and then slowly |
| | starts dissolving up to 48 |
| | hours |
| 2.00 | After 72 hours of immersion |
| 5.00 | After 72 hours of immersion |
| 10.00 | After 24 hours of immersion |

Similar experiments were performed for GH3 nanofibers cross-linked with EDC-NHS coupling. It was observed that they remain stable for more than 5 days in DI water. It was observed that there were changes in morphology of the nanofibers mat while immersion in DI water, probably the mat was swelled and achieved its equilibrium swelling. It is observed that 8 hours of cross-linking using EDC-NHS coupling was too much since the nanofiber's diameters increased and also, they were not retaining their structure and morphology.

G) Effect of Cross-linking time on GEL (15% w/v), G2500 nanofibers loaded with 0%, 1% & 3% w/w Halloysite nanoclay, G, GH1 & GH3 respectively using EDC-NHS coupling: For this experiment the ex vivo approach as was described in the crosslinking method was followed. Briefly, 50 mM of EDC/NHS (2.5:1 molar ratio) have been prepared using acetonitrile as a solvent. The already prepared gelatin nanofibers mats G, GH1 and GH3 were cut into 4 pieces of dimensions 2×2 cm², each piece was dipped in the above solution and kept for 30 minutes, 1 hour, 2 hours and 4 hours of cross-linking reaction time. The rest of the procedure was same as explained earlier. It is observed that with increase in time-period of cross-linking, the nanofibers are merging with each-other and their diameter also increases. With 1 hour of cross-linking, the nanofiber mats were retaining their structure for all three compositions.

H) Fabrication of GH3 nanofibers incorporated with Cross-linked EC-PVA nanoparticles with/without diuron loading: The GH3 nanofibers mats were fabricated with the incorporation of 30% (w/w of gelatin) of plain Cross-linked EC-PVA nanoparticles by electrospinning. Further, they were cross-linked using EDC-NHS coupling reaction at various exposure time viz., 30 minutes, 1 hour, 2 hours & 4 hours. They were considered as control for drug release studies. The GH3 nanofibers mats were fabricated with the incorporation of 30% (w/w of gelatin) of Cross-linked EC-PVA nanoparticles loaded with 10% (w/w of EC) of diuron using electrospinning. Further, they were cross-linked using EDC-NHS coupling reaction at various exposure time viz., 30 minutes, 1 hour, 2 hours & 4 hours (FIG. 7a-d). They were considered as samples for release studies.

I) In vitro drug release studies of various cross-linked GH3 nanofibers incorporated with diuron loaded Cross-linked EC-PVA nanoparticles: The release profiles of diuron from the different time dependent cross-linked GH3 nanofibers incorporated with diuron-loaded Cross-linked EC-PVA nanoparticles were studied via dispersing 5 mg of control and sample nanofibers (as mentioned in the FIGS. 9 & 10) in 2 mL of distil water with 1% w/v sodium azide and enclosing them in dialysis membrane tubes (Mw cut-off: 12 kDa). These dialysis bags were kept in 18 mL of the same solvent as was inside the dialysis bags and were incubated at 37° C. in a shaker bath (Julabo SW23) at 50 rpm. At regular intervals of time, 1 mL was withdrawn from the solvent and 1 mL of fresh solvent was added to maintain the sink conditions. The withdrawn solvent was analyzed for the amount of diuron released using a UV-vis spectrophotometer at 251 nm. The release behaviour of diuron from EC nanoparticles incorporated into time dependent cross-linked GH3 nanofibers was depicted in FIG. 8. It shows that the release behaviour of diuron was certainly affected by the cross-linking time for which the GH nanofibers were subjected. With increase in cross-linking time the cumulative percentage release (CPR) decreases for instance 1 hour of cross-linking gave approx. 75% CPR while 4 hours of cross-linking lead to approx. 37% CPR. All nanofibers' compositions display a sustained release for up to 14 days.

### Example 4: Preparation of Double Encapsulated Composition Using Herbicide Diuron and Plant Growth Regulator/Promoter Ascorbic Acid, and the Encapsulations of Example 1 and 3

TABLE 10
Formulation parameters and compositions of nanocomposites granules

| | | | | | | Solvent System |
|---|---|---|---|---|---|---|
| | G2500 | HN | EC (ethyl | | AA | H₂O:DMA |
| | (Gelatin | (halloysite | cellulose) | DCMU | (ascorbic | (water:dimeth- |
| | with bloom | nanoclay) | Nps (% | (diuron) | acid) (% | ylamide) |
| | no. 300) | (% w/w wrt | w/w wrt | (% w/w | w/w wrt | [50:50 v/v] |
| Compositions | (% w/v) | G2500) | G2500) | wrt EC) | G2500) | (mL) |
| NG0 | 15 | 3 | 0 | 0 | 0 | 2 |
| NG1 | 15 | 3 | 0 | 0 | 10 | 2 |
| NG2 | 15 | 3 | 0 | 0 | 20 | 2 |
| NG3 | 15 | 3 | 30 | 0 | 0 | 2 |
| NG4 | 15 | 3 | 30 | 10 | 0 | 2 |
| NG5 | 15 | 3 | 30 | 10 | 10 | 2 |
| NG6 | 15 | 3 | 30 | 10 | 20 | 2 |

A) Preparation of AA loaded GEL solution with the incorporation of halloysite nanoclay and its electrospinning into composite nanofibers: GEL (15% w/v) was prepared by first dissolving calculated amount in water (1 mL) through autoclaving (121° C., 15 minutes) and was kept at 45° C. until mixing. After mixing, the solution was cooled down to ambient temperature and the previously optimized concentration of Halloysite nanoclay was added at 3% (w/w wrt to GEL content) and kept for stirring at ambient temperature for 30 minutes. Later, calculated amount of AA was added to the GEL solution at two different concentrations 10 and 20% (v/v wrt GEL content) and allowed to mix at ambient temperature for 30 minutes on a magnetic stirrer [Note: AA is light sensitive, so the vial containing the GEL solution was covered with aluminum foil before addition of AA under dark conditions]. Further, equal volumes of the AA loaded GH3 solution and N, N-dimethyl acetamide (DMA), a polar organic solvent, were mixed and kept on magnetic stirrer at ambient temperature for overnight stirring. Next, the prepared homogeneous AA loaded GH3 solutions were filled in 2 mL syringes, equipped with a stainless-steel hypodermic needle with blunt end of fixed pore. The filled syringe was mounted on the syringe pump of the electrospinning unit. A high-voltage generator operated in a positive DC mode was connected to the syringe needle, and an aluminum plate was set in a closed chamber to ground the nanofibers. Electrospinning was done at ambient conditions, and the parameters were fixed as previously described; the distance between the tip of the needle and the collector kept to 12 cm, the voltage fixed to 15 kV, and the flow rate was 0.3 mL/h. The nanofibers mats were collected from the aluminum foils. Cross-linking was done as described earlier via EDC-NHS coupling reaction at the exposure time of 1 hour.

B) Fabrication of AA loaded GH3 nanofibers incorporated with Cross-linked EC-PVA nanoparticles with diuron loading: The GH3 nanofibers mats were fabricated with the incorporation of 30% (w/w of gelatin) of diuron loaded cross-linked EC-PVA nanoparticles by electrospinning. The protocol followed was similar as described for AA loaded GH3 nanofibers with some additional steps like (a) addition of diuron loaded EC-PVA nanoparticles before the addition of nanoclay and kept for stirring of 1 hour at 45° C., (b) probe sonication at 40 amplitudes, pulse rate 5/5 ON/OFF for 2 minutes, 2 cycles and (c) bath sonication for 15 minutes to remove air bubbles, 2 cycles at the end before keeping for electrospinning. Cross-linking was done as described earlier via EDC-NHS coupling reaction at the exposure time of 1 hour.

C) Morphology Study: FIG. 9 demonstrates the FESEM micrographs of gelatin nanofibers incorporated with 3% w/w Halloysite nanoclay incorporated with (a) ascorbic acid (AA) and (b) with both AA & diuron loaded EC Nps. From the figure, it was observed that the composite gelatin nanofibers incorporated with ascorbic acid were randomly aligned, beadles, interconnected, continuous and with the addition of diuron loaded EC Nps their diameter decreases from 221 nm to 206 nm. It was also observed that the cross-linking causes an increase in the average diameter of nanofibers by 60% (refer table 11) and the merging of nanofibers occurred throughout the nanofibers mat's surface.

TABLE 11
Size of GH3 composite nanofibers incorporated with
ascorbic acid (AA) and with both AA & diuron
loaded EC Nps with and without cross-linking.
Data displayed as mean ± SD.

| Formulations | Diameter (nm) |
|---|---|
| NG1 Uncross-linked | 221 ± 68 |
| NG5 Uncross-linked | 206 ± 76 |
| NG1 Cross-linked | 383 ± 90 |
| NG5 Cross-linked | 334 ± 153 |

D) Estimation of entrapment efficiency and loading efficiency: Preparation of co-factor (Ascorbic Acid) standard curve in distilled water:

Preparation of standard stock solution and standard curve of AA: The standard curve of AA was prepared by making standard solutions of AA in distilled water with 0.1% (w/w) sodium azide in the concentration range of 2 to 14 μg/mL and doing their UV-visible spectrometric analysis at λₘₐₓ of 266 nm.

Entrapment efficiency and loading efficiency of AA: The entrapment and loading efficiency of AA in-to the composite nanofibers GH3 and GH3ECD were determined by calculating the entrapped AA present in the uncross-linked nanofibers mat obtained during the preparation of AA incorporated GH3 and GH3ECD nanofibers mat as explained earlier. In brief, a known amount of uncross-linked nanofibers mat was dissolved in 1 mL of DI water, and then centrifuged @15,000 rpm for 15 minutes. The entrapped AA comes out into the supernatant and the concentration present was estimated using the standard calibration curve of AA at 2max of 266 nm and was analyzed using a UV-Visible spectrophotometer (UV 1601PC UV spectrophotometer, Shimadzu, Japan). The percentage of entrapment efficiency (% EE) and the percentage of loading efficiency (% LE) was estimated using eqn. (1), and eqn. (2) respectively.

$$\% EE = \frac{( Wt . of AA present in the supernatant )}{( Wt . of initial AA used )} \times 100 \qquad ( 1 )$$

$$\% LE = \frac{( Wt . of AA present in the supernatant )}{( Wt . of initial nanofibers mat used )} \times 100 \qquad ( 2 )$$

TABLE 12
The drug loading efficiency (LE) and encapsulation
efficiency (EE) of AA incorporated composite
nanofibers GH3, cross-linked via EDC-NHS
coupling mechanism with a reaction time of 1 h.

| | Loading | Encapsulation |
|---|---|---|
| | efficiency | efficiency |
| Compositions | (% LE) | (% EE) |
| GA10 | 2.16 | 21.64 |
| GA20 | 7.73 | 38.63 |

From the table 12, it was observed that both the loading efficiency and encapsulation efficiency achieved are very low compared to the available literature. It is because of loss of AA during the nanofibers fabrication process caused by instability/oxidation against temperature and light conditions. But, these values are obtained without any functionalization/modification of the AA. Still, by incorporating AA into the composite nanofibers, the stability of the AA enhances.

TABLE 13
The percentage drug loading efficiency (% LE) and
percentage drug encapsulation efficiency (% EE) of
AA and Diuron in AA incorporated composite
nanofibers GH3 loaded with EC Nps with 10%
(w/w wrt EC) Diuron, cross-linked via EDC-NHS
coupling mechanism with a reaction time of 1 hour.

| | AA | Diuron | AA | Diuron |
|---|---|---|---|---|
| | Loading | Loading | Encapsulation | Encapsulation |
| | efficiency | efficiency | efficiency (% | efficiency (% |
| Compositions | (% LE) | (% LE) | EE) | EE) |
| GA10ECD | 1.61 | 2.00 | 16.05 | 65.59 |
| GA20ECD | 4.80 | 3.08 | 23.99 | 98.32 |

The loading efficiency (LE %) and encapsulation efficiency (EE %) of AA and diuron respectively are compared in table 13, it was observed that both AA and diuron LE % & EE % are compromised when they both are incorporated in the GH3 nanofibers. Comparison of table 12 and 13 leads to the interpretation that with increase in the AA conc. in the composite nanofibers GH3 the decrease in EE % and LE % can be compensated in the presence of EC Nps loaded diuron i.e., double encapsulation stabilizes the whole formulation and gives effects in terms of herbicide/weedicide and also, plant growth promoter/regulator.

### In Vitro Drug Release Study:

In Vitro Drug Release Studies of Cross-Linked GH3 Nanofibers Loaded with AA and Incorporated with Diuron Loaded Cross-Linked EC-PVA Nanoparticles:

The release profiles of diuron from the composite GH3 nanofibers incorporated with AA and diuron-loaded Cross-linked EC-PVA nanoparticles [cross-linked for 1 hour via. EDC-NHS coupling] were studied via dispersing known amount of control and sample nanofibers in 1 mL of distil water with 1% w/v sodium azide in eppendroff tubes and were incubated at 37° C. in a shaker bath (Julabo SW23) at 50 rpm. At different time intervals, the whole 1 mL sink medium was collected in separate fresh eppendroff tubes and fresh 1 mL sink medium was added to the eppendroff tubes containing the nanofibers mat samples to maintain the sink conditions. The withdrawn sink medium was analyzed for the amount of AA and diuron released during the study of 24 h using a UV-Visible spectrophotometer at λmax of 266 nm and 251 nm, respectively.

The release behaviour of AA and diuron from the composite GH3 nanofibers incorporated with AA and diuron-loaded Cross-linked EC-PVA nanoparticles [cross-linked for 1 hour via. EDC-NHS coupling] are compared in FIG. 11 (a-c). Refer to FIG. 11(a), the release profile of AA from GA10ECD0 and GA20ECD0 shows burst release both in case of AA10 and AA20 with the maximum release obtained within 1 hour of 3.5% and 16.5% respectively. It shows that the cumulative percentage release (CPR) of AA was concentration dependent (see the inset in FIG. 11 (a)). In comparison to AA, DCMU shows a sustained release profile from GA0ECD30, since it is blended with the EC matrix (a hydrophobic system) and incorporated into the GH3 (a hydrophilic system). Both these opposite interactions control the release of DCMU.

The FIGS. 11 (b) and (c) shows that the release behaviour of both AA & diuron are affected by each other's presence in the nanofibers. The CPR within 15 minutes for both AA and diuron are comparatively lesser when they are individually present in the composite nanofibers than when they are both present together. Further, with the increase in AA initial conc. in the nanofibers, the CPR at the same time point of 15 minutes increases from 2% to 23% for AA and from 3% to 19% for diuron (refer insets of FIG. 11 (b-c)).

### ADVANTAGES OF THE PRESENT INVENTION

1) The present disclosure provides a method to fabricate nanofibers of gelatin alone by changing only the solvent system (a combination of polar (water) and non-polar (DCM) solvents). It is very difficult to fabricate nanofibers with gelatin alone, since it is extremely water instable and highly temperature sensitive and inventors have reported fabrication by blending it with other thermally stable polymers.
2) The present disclosure provides a method of incorporation of herbicide-loaded cross-linked EC-PVA nanoparticles in the cross-linked gelatin-nanoclay nanofibers without using any additional solvent, while retaining its structure and morphology without affecting the size and shape.
3) The present disclosure provides a system to fine tune the herbicide-release profile by varying the time duration of crosslinking reaction and hence, can achieve a slow and sustained release profile up to 14 days.

We claim:

1. A double encapsulated nanocomposite composition, comprising:
i. a cross-linked ethyl cellulose (EC) nanoparticles,
ii. 1^{st} active ingredient,
iii. cross-linked gelatin-nanoclay nanofibers, and
iv. 2^{nd} active ingredient;
wherein the cross-linked EC nanoparticles and 1^{st} active ingredient are combined to prepare 1^{st} active ingredient-loaded cross-linked EC nanoparticles as 1^{st} encapsulation,
wherein the cross-linked gelatin-nanoclay nanofibers and 2^{nd} active ingredient are combined to prepare 2^{nd} active ingredient-loaded cross-linked gelatin-nanoclay nanofibers, and
wherein the 1^{st} active ingredient-loaded cross-linked EC nanoparticles is within a mat comprising of said 2^{nd} active ingredient-loaded cross-linked gelatin-nanoclay nanofiber forming said double encapsulated nanocomposite composition.

2. The double encapsulated nanocomposite composition as claimed in claim 1, wherein the cross-linked ethyl cellulose (EC) nanoparticles comprises polyvinyl alcohol as stabilizer; wherein the 1^{st} active ingredient and 2^{nd} active ingredient are same or different, and are selected from herbicide, plant growth stimulator, nutrient, plant disease controlling agent, antibiotic, nucleic acid, and mixture thereof; wherein the herbicide is selected from triazine, chloroacetamide, 2,6-dinitroaniline, aclonifen, diuron, hydroxybenzonitrile, 2,4-D, aminopyralid, atrazine, clopyralid, dicamba, glufosinate ammonium, fluazifop, fluroxypyr, imazapyr, imazamox, metolachlor, pendimethalin, picloram, triclopyr, mesotrione and glyphosate; wherein the plant growth stimulator is selected from plant growth hormone, auxin, gibberellins, cytokinin, ABA, ethylene and growth promoting agent; wherein the plant growth hormone is selected from indole 3 acetic acid, indole butyric acid, naphthalene acetic acid, methyl ester of naphthalene acetic acid, 2 methyl 4-chloro phenoxy acetic acid, 2, 3, 5 Tri iodo benzoic acid, 2, 4 dichloro phenoxy acetic acid, 2, 4, 5-trichloro phenoxy acetic acid, gibberellic acid, kinetin, coconut milk factor and zeatin; wherein the growth promoting agent is selected from ascorbic acid, strigol, orobanchol, GR24 (synthetic strigolactone), epi-GR24 (synthetic strigolactone), and 5-(4-chlorophenoxy)-3-methylfuran-2 (5H)-one (CPMF); wherein the nutrient is selected from macronutrient and micronutrient; wherein the macronutrient is selected from salts of C, H, O, N, P, K, Ca, Mg and S; wherein the micronutrient is selected from salts of Fe, Mn, Zn, Cu, B, and Cl; wherein the plant disease controlling agent is selected from tebuconazole, epoxiconazole, prothioconazole, difenoconazole, propiconazole, cyproconazole, metconazole, triflumizole, tebuconazole and difenoconazole, pefurazoate, ipconazole; wherein the antibiotic is selected from agrocin 84, bacillomycin D, bacillomycin, fengycin, xanthobaccin A, gliotoxin, herbicolin, iturin A, mycosubtilin, phenazines, pyoluteorin, pyrrolnitrin, pseudane, zwittermicin A, 2,4-diacetylphloroglucinol (2,4-DAPG), phenazine-1-carboxylic acid (PCA), kanosamine, oligomycin A, butyrolactones, xanthobaccin, and viscosinamide; and wherein the nucleic acid is RNA.

3. The double encapsulated nanocomposite composition as claimed in claim 1, wherein the cross-linked gelatin-nanoclay nanofibers are selected from cross-linked squaric acid, cross-linked Irgacure 2959 and crosslinked EDC-NHS coupled gelatin-nanoclay nanofibers.

4. The double encapsulated nanocomposite composition as claimed in claim 1, wherein the cross-linked ethyl cellulose (EC) nanoparticles are present in a range of 5-50% w/w; wherein the cross-linked gelatin-nanoclay nanofibers are present in a range of 10-30% w/v; wherein the 1^{st} active ingredient is present in a range of 5-50% w/w; and wherein the 2^{nd} active ingredient is present in a range of 5-50% w/w.

5. The double encapsulated nanocomposite composition as claimed in claim 1, wherein the composition is sustained release formulation or controlled release formulation; and wherein diameter of the mat is in a range of 50 to 1000 nm.

6. The double encapsulated nanocomposite composition as claimed in claim 1, wherein diameter of the 1^{st} active ingredient-loaded cross-linked EC nanoparticles is in a range of 50 nm to 500 nm; and diameter of the 2^{nd} active ingredient-loaded cross-linked gelatin-nanoclay nanofiber is in a range of 1 to 500 nm.

7. The double encapsulated nanocomposite composition as claimed in claim 1, wherein the mat is non-woven nanofibers mat with fiber diameter ranging from 50-800 nm.

8. A process of preparation of a double encapsulated nanocomposite composition, the process comprising:
a) preparing ethyl cellulose (EC) nanoparticles by treating ethyl cellulose (EC) with polyvinyl alcohol (PVA) as stabilizer in presence of 1^{st} active ingredient, followed by cross-linking the nanoparticles using CaCl₂ to obtain 1^{st} encapsulation of active ingredient as 1^{st} active ingredient-loaded cross-linked EC nanoparticles;
b) mixing 1^{st} active ingredient-loaded cross-linked EC nanoparticles in the solution of gelatin-nanoclay to obtain 1^{st} active ingredient loaded double encapsulated nanofibers;
c) mixing the 2^{nd} active ingredient and 1^{st} active ingredient loaded crosslinked EC nanoparticles in the solution of gelatin-nanoclay to obtain double encapsulated nanofibers;
d) preparing cross-linked gelatin-nanoclay nanofibers by treating nanofibers with a specific amount of crosslinkers to obtain the final double encapsulated nanocomposite composition; wherein the specific amount of crosslinkers is 0.05-50% w/w with respect to the gelatin.

9. The process as claimed in claim 8, wherein the step a) comprising the steps of:
i. mixing EC and 1^{st} active ingredient in dichloromethane (DCM) solvent, followed by stirring for a time period of 8 to 12 hours to obtain an EC-1^{st} active ingredient mixture;
ii. providing a PVA solution;
iii. slowly adding the EC-1^{st} active ingredient mixture into the PVA solution, followed by sonication to obtain a dispersed solution;
iv. centrifuging the dispersed solution to obtain a pellet;
V. washing the pellet using water or DI water;
vi. dispersing the washed pellet in CaCl₂ solution for cross-linking, followed by stirring to obtain 1^{st} active ingredient-loaded cross-linked EC nanoparticles; and
vii. washing the 1^{st} active ingredient-loaded cross-linked EC nanoparticles, followed by drying to obtain 1^{st} active ingredient-loaded cross-linked EC nanoparticles.

10. The process as claimed in claim 9, wherein the PVA solution is 0.1-1% w/v of PVA dissolved in water; wherein the EC mixture is 10% w/v of EC powder dissolved in DCM solvent; wherein the amount of 1^{st} active ingredient in said 1^{st} active ingredient-loaded cross-linked EC nanoparticles is in the range of ranges 1% w/v to 20% w/v with respect to the weight of EC; wherein a ratio of EC+1^{st} active ingredient: PVA is in the range of 1:2 to 1:8; and wherein a concentration of CaCl₂ is in the range of 0.2% w/v to 10% w/v.

11. The process as claimed in claim 8, wherein the step b) comprising:
i. providing a gelatin solution;
ii. mixing a nanoclay in said gelatin solution, followed by stirring to obtain a homogeneous blend solution;
iii. preparing gelatin-nanoclay nanofibres by electrospinning method at temperature between 25° C.-40° C.; and
iv. preparing cross-linked gelatin-nanoclay nanofibres by in situ or ex-situ method to obtain cross-linked gelatin-nanoclay nanofibers.

12. The process as claimed in claim 11, wherein the nanoclay is halloysite nanoclay; wherein the gelatin solution is prepared by dissolving gelatin in water in an amount ranging from about 1% w/v to 20% w/v; wherein amount of nanoclay is in the range of 0.5% w/v to 10% w/v with respect to the weight of gelatin; and wherein amount of the 2^{nd} active ingredient is in the range of 0.5% w/v to 15% w/v with respect to the weight of gelatin.

13. The process as claimed in claim 11, wherein the electrospinning method comprises: a) filling of the homogeneous gelatin-nanoclay solution in a syringe, equipped with a stainless-steel hypodermic needle with a blunt end with a fixed pore; b) mounting the filled syringe on a syringe pump of an electrospinning unit connected with a high-voltage generator operated in a positive DC mode, and an aluminum plate is set in a closed chamber to ground the nanofibers; and c) the ambient conditions for electrospinning comprises a distance between tip of the needle and the collector is in a range of 5-35 cm, the voltage is in a range of 10-50 kV, and the flow rate is in a range of 0.05-5.00 mL/h.

14. The process as claimed in claim 11, wherein the in-situ method of preparing cross-linked gelatin-nanoclay nanofibres comprises incorporating a cross-linker directly into the gelatin solution for cross-linking and then fabricating it into nanofibers; wherein the ex-situ method of preparing cross-linked gelatin-nanoclay nanofibres comprises dipping the nanofibers from step c) into a solution of cross-linker; and wherein the cross-linker is selected from EDC-NHS (zero length cross-linker), squaric acid (SQ) (non-zero length cross-linker) and 2-hydroxy-1-(4 (hydroxyethoxy)phenyl)-2-methyl-1-propanone (photo-initiator cross-linker).
